(19) United States
(12) Patent Application Publication
(10) Pub. No.: US 2014/0251266 A1
(43) Pub. Date: Sep. 11, 2014

(54) Auxiliary Valve Motions Employing Disablement of Main Valve Events and/or Coupling of Adjacent Rocker Arms

(71) Applicant: Jacobs Vehicle Systems, Inc., Bloomfield, CT (US)

(72) Inventors: Kristin V. EMMONS, Amston, CT (US); Joseph M. VORIH, Suffield, CT (US); Kevin P. GROTH, Southington, CT (US); Brian L. RUGGIERO, East Granby, CT (US); Shengqiang HUANG, West Simsbury, CT (US); Neil E. FUCHS, New Hartford, CT (US); John J. LESTER, West Hartford, CT (US); Steven N. ERNEST, Windsor, CT (US); Joseph PATURZO, Avon, CT (US)

(73) Assignee: Jacobs Vehicle Systems, Inc., Bloomfield, CT (US)

(21) Appl. No.: 14/285,904

(22) Filed: May 23, 2014

Related U.S. Application Data
(63) Continuation-in-part of application No. 13/192,330, filed on Jul. 27, 2011.
(60) Provisional application No. 61/827,568, filed on May 25, 2013.

(51) Int. Cl. F02D 13/04

(52) U.S. Cl. CPC F02D 13/04
USPC 123/321

(57) ABSTRACT

In controlling valve motions of an internal combustion engine, after determining that engine braking operation has been initiated, a deactivation mechanism disposed within a main valve train is activated thereby disabling conveyance of main valve events from a main valve motion source to a valve via the main valve train. Engine braking valve events are enabled for the valve, which may include two-stroke engine braking. Coupling mechanisms, including one-way coupling mechanisms, between adjacent rocker arms may be used in this manner.

### CROSS-REFERENCE TO RELATED APPLICATION

The instant application is a continuation-in-part of co-pending application entitled “Combined Engine Braking And Positive Power Engine Lost Motion Valve Actuation System,” application Ser. No. 13/192,330, filed on Jul. 27, 2011, the teachings of which are incorporated herein by this reference. The instant application additionally claims the benefit of Provisional U.S. Patent Application Ser. No. 61/827,568 entitled “Pin Lock Rocker” and filed on May 25, 2013, the teachings of which are incorporated herein by this reference.

### FIELD

The present invention relates generally to systems and methods for actuating one or more engine valves in an internal combustion engine. In particular, the invention relates to systems and methods for valve actuation including a lost motion system. Embodiments of the present invention may be used during positive power and engine braking operation of an internal combustion engine.

### BACKGROUND

Valve actuation in an internal combustion engine is required in order for the engine to produce positive power, and may also be used to produce auxiliary valve events. During positive power, intake valves may be opened to admit fuel and air into a cylinder for combustion. One or more exhaust valves may be opened to allow combustion gas to escape from the cylinder. Intake, exhaust, and/or auxiliary valves may also be opened during positive power at various times for exhaust gas recirculation (EGR) for improved emissions.

Engine valve actuation also may be used to produce engine braking and brake gas recirculation (BGR) when the engine is not being used to produce positive power. During engine braking, one or more exhaust valves may be selectively opened to convert, at least temporarily, the engine into an air compressor. In doing so, the engine develops retarding horsepower to help slow the vehicle down. This can provide the operator with increased control over the vehicle and substantially reduce wear on the service brakes of the vehicle.

Engine valve(s) may be actuated to produce compression-release braking and/or bleeder braking. The operation of a compression-release type engine brake, or retarder, is well known. As a piston travels upward during its compression stroke, the gases that are trapped in the cylinder are compressed. The compressed gases oppose the upward motion of the piston. During engine braking operation, as the piston approaches the top dead center (TDC), at least one exhaust valve is opened to release the compressed gases in the cylinder to the exhaust manifold, preventing the energy stored in the compressed gases from being returned to the engine on the subsequent expansion down-stroke. In doing so, the engine develops retarding power to help slow the vehicle down. An example of a prior art compression release engine brake is provided by the disclosure of Cummins, U.S. Pat. No. 3,220,392, which is incorporated herein by reference.

The operation of a bleeder type engine brake has also long been known. During engine braking, in addition to the normal exhaust valve lift, the exhaust valve(s) may be held slightly open continuously throughout the remaining engine cycle (full-cycle bleeder brake) or during a portion of the cycle (partial-cycle bleeder brake). The primary difference between a partial-cycle bleeder brake and a full-cycle bleeder brake is that the former does not have exhaust valve lift during most of the intake stroke. An example of a system and method utilizing a bleeder type engine brake is provided by the disclosure of U.S. Pat. No. 6,594,996, which is incorporated herein by reference.

The basic principles of brake gas recirculation (BGR) are also well known. During engine braking the engine exhausts gas from the engine cylinder to the exhaust manifold and greater exhaust system. BGR operation allows a portion of these exhaust gases to flow back into the engine cylinder during the intake and/or expansion strokes of the cylinder piston. In particular, BGR may be achieved by opening an exhaust valve when the engine cylinder piston is near bottom dead center position at the end of the intake and/or expansion strokes. This recirculation of gases into the engine cylinder may be used during engine braking cycles to provide significant benefits.

In many internal combustion engines, the engine intake and exhaust valves may be opened and closed by fixed profile cams, and more specifically by one or more fixed lobes or bumps which may be an integral part of each of the cams. Benefits such as increased performance, improved fuel economy, lower emissions, and better vehicle drivability may be obtained if the intake and exhaust valve timing and lift can be varied. The use of fixed profile cams, however, can make it difficult to adjust the timings and/or amounts of engine valve lift to optimize them for various engine operating conditions.

One method of adjusting valve timing and lift, given a fixed cam profile, has been to provide a “lost motion” device in the valve train linkage between the valve and the cam. Lost motion is the term applied to a class of technical solutions for modifying the valve motion proscribed by a cam profile with a variable length mechanical, hydraulic, or other linkage assembly. In a lost motion system, a cam lobe may provide the “maximum” (longest dwell and greatest lift) motion needed over a full range of engine operating conditions. A variable length system may then be included in the valve train linkage, intermediate of the valve to be opened and the cam providing the maximum motion, to subtract or lose part or all of the motion imparted by the cam to the valve.

Some lost motion systems may operate at high speed and be capable of varying the opening and/or closing times of an engine valve from engine cycle to engine cycle. Such systems are referred to herein as variable valve actuation (VVA) systems. VVA systems may be hydraulic lost motion systems or electromagnetic systems. An example of a known VVA system is disclosed in U.S. Pat. No. 6,510,824, which is hereby incorporated by reference.

Engine valve timing may also be varied using cam phase shifting. Cam phase shifters vary the time at which a cam lobe actuates a valve train element, such as a rocker arm, relative to the crank angle of the engine. An example of a known cam phase shifting system is disclosed in U.S. Pat. No. 5,934,263, which is hereby incorporated by reference.

Cost, packaging, and size are factors that may often determine the desirableness of an engine valve actuation system. Additional systems that may be added to existing engines are often cost-prohibitive and may have additional space requirements due to their bulky size. Pre-existing engine brake systems may avoid high cost or additional packaging, but the size of these systems and the number of additional components may often result in lower reliability and difficulties with size. It is thus often desirable to provide an integral engine valve actuation system that may be low cost, provide high performance and reliability, and yet not provide space or packaging challenges.

Embodiments of the systems and methods of the present invention may be particularly useful in engines requiring valve actuation for positive power, engine braking valve events and/or BGR valve events. Some, but not necessarily all, embodiments of the present invention may provide a system and method for selectively actuating engine valves utilizing a lost motion system alone and/or in combination with cam phase shifting systems, secondary lost motion systems, and variable valve actuation systems. Some, but not necessarily all, embodiments of the present invention may provide improved engine performance and efficiency during engine braking operation. Additional advantages of embodiments of the invention are set forth, in part, in the description which follows and, in part, will be apparent to one of ordinary skill in the art from the description and/or from the practice of the invention.

### SUMMARY

Responsive to the foregoing challenges, Applicants have developed innovative systems for actuating one or more engine valves for positive power operation and engine braking operation. In an embodiment, a method for performing engine braking includes, after a determination has been made that engine braking operation has been initiated, activation of a deactivation mechanism disposed within a main valve train, thereby disabling conveyance of main valve events from a main valve motion source to a valve via the main valve train. Additionally, in response to the initiation of engine braking, engine braking valve events are enabled for the valve, which may include coupling of adjacent rocker arms. In an embodiment, the engine braking valve events implement two-stroke engine braking. The deactivation mechanism may be disposed virtually anywhere along the main valve train between the main valve motion source and the valve. Further, the deactivation mechanism may be hydraulically activated/deactivated and may comprise a collapsing mechanism configured to lose substantially all of the main valve events when activated.

In another embodiment, a method for performing engine braking is disclosed in a system comprising a plurality of rocker arms operatively connected to a plurality of valve actuation motion sources, wherein the plurality of rocker arms are arranged adjacent each other such that boundaries are defined therebetween and wherein the plurality of rocker arms comprise at least one coupling mechanism for each boundary. In this method, a determination is made that engine braking operation has been initiated and, thereafter, the at least one coupling mechanism is controlled to couple a first rocker arm to a second rocker arm, the first rocker arm being operatively connected to at least one valve and the second rocker arm being operatively connected to an engine braking motion source. In this manner, engine braking valve events may be conveyed from the engine braking motion source to the valve via the first and second rocker arms. Furthermore, responsive to the initiation of engine braking operation, the at least one coupling mechanism may also be controlled to decouple the first rocker arm from a third rocker arm, the third rocker arm being operatively connected to a main event motion source. In an embodiment, the engine braking motion source implements two-stroke engine braking. Thereafter, following a determination that positive power operation has been initiated, the at least one coupling mechanism may be controlled to decouple the first rocker arm from the second rocker arm, thereby discontinuing provision of engine braking valve events to the valve. Further still, responsive to the determination that positive power operation has been initiated, the at least one coupling mechanism may be controlled to couple the first rocker arm to the third rocker arm such that main valve events may be conveyed from the main event motion source to the valve via the first and third rocker arms.

In another embodiment, a system for controlling valves in an internal combustion engine comprises a main event motion source operatively connected to a main rocker arm, an auxiliary motion source operatively connected to an auxiliary rocker arm and a neutral rocker arm operatively connected to at least one valve and disposed adjacent to the main rocker arm and the auxiliary rocker arm. The system further comprises a main coupling mechanism, configured to selectively couple or decouple the main rocker arm and the neutral rocker arm, and an auxiliary coupling mechanism, configured to selectively couple or decouple the auxiliary rocker arm and the neutral rocker arm. In one implementation, the auxiliary coupling mechanism may comprise bores formed in the auxiliary rocker arm and the neutral rocker arm and an auxiliary sliding member disposed in one or the other of the bores. The bores thus formed are configured to align with each other. An auxiliary hydraulic passage may be provided in either the auxiliary rocker arm or the neutral rocker arm in fluid communication with the corresponding bore such that the auxiliary sliding member may be extended out of its bore and into the other bore when the auxiliary hydraulic passage is charged with hydraulic fluid, thereby coupling the auxiliary rocker arm and the neutral rocker arm together. Various configurations of biasing mechanisms, which may be disposed in the same bore as the auxiliary sliding member or in the bore opposite the auxiliary sliding member, may be employed to bias the auxiliary sliding member into its bore. To implement the main coupling mechanism, the main rocker arm and neutral rocker arm may comprise a similar configuration of bores, a main sliding member, main hydraulic passage and biasing mechanism. In an embodiment, separate bores may be provided in the neutral rocker arm corresponding to the auxiliary and main sliding members. Alternatively, the bore in the neutral rocker arm used to receive the auxiliary sliding member may also be used to receive the main sliding member. In this latter embodiment, a neutral sliding member may be provided in the bore in the neutral rocker arm.

In yet another embodiment, a system for controlling valves in an internal combustion engine comprises a main event motion source operatively connected to a main rocker arm and an auxiliary motion source operatively connected to an auxiliary rocker arm. The main rocker arm is also operatively connected to at least one valve. The system further comprises a one-way coupling mechanism, configured to selectively couple or decouple the main rocker arm and the auxiliary rocker arm. When the main rocker arm and the auxiliary rocker arm are coupled via the one-way coupling mechanism, auxiliary valve motions are transferred from the auxiliary rocker arm to the main rocker arm, however the main event valve motions are not transferred from the main rocker arm to the auxiliary rocker arm. The one-way coupling mechanism may be disposed within the auxiliary rocker arm or the main rocker arm, and may comprise an auxiliary sliding member that is hydraulically extendable out of a bore formed in the corresponding rocker arm. In turn, the auxiliary sliding member may contact an upward facing surface, a downward facing surface or a slot formed in the other rocker arm.

In all instances, the valve motions provided by the auxiliary motion source may comprise engine braking valve motions (including two-stroke engine braking valve motions) and non-engine braking valve motions.

It is to be understood that both the foregoing general description and the following detailed description are exemplary and explanatory only, and are not restrictive of the invention as claimed.

### BRIEF DESCRIPTION OF THE DRAWINGS

In order to assist the understanding of this invention, reference will now be made to the appended drawings, in which like reference characters refer to like elements.

FIG. 1 is a pictorial view of a valve actuation system configured in accordance with a first embodiment of the present invention.

FIG. 2 is a schematic diagram in cross section of a main rocker arm and locking valve bridge configured in accordance with the first embodiment of the present invention.

FIG. 3 is a schematic diagram in cross section of an engine braking rocker arm configured in accordance with the first embodiment of the present invention.

FIG. 4 is a schematic diagram of an alternative engine braking valve actuation means in accordance with an alternative embodiment of the present invention.

FIG. 5 is a graph illustrating exhaust and intake valve actuations during a two-cycle engine braking mode of operation provided by embodiments of the present invention.

FIG. 6 is a graph illustrating the exhaust valve actuations during a two-cycle engine braking mode of operation provided by embodiments of the present invention.

FIG. 7 is a graph illustrating the exhaust valve actuation during a failure mode of operation provided by embodiments of the present invention.

FIG. 8 is a graph illustrating exhaust and intake valve actuations during a two-cycle engine braking mode of operation provided by embodiments of the present invention.

FIG. 9 is a graph illustrating exhaust and intake valve actuations during a two-cycle compression release and partial bleeder engine braking mode of operation provided by embodiments of the present invention.

FIG. 10 is a block diagram of a valve actuation system in accordance with the various embodiments of the instant disclosure;

FIGS. 11 and 12 are flow charts illustrating methods for performing engine braking in accordance with embodiments of the instant disclosure;

FIGS. 13 and 14 are top, partial cross-sectional views of a plurality of engine valves in accordance with a third embodiment of the instant disclosure;

FIG. 15 is a top, partial cross-sectional view of a plurality of engine valves in accordance with a fourth embodiment of the instant disclosure;

FIGS. 16 and 17 are magnified, top, cross-sectional views of an alternate biasing mechanism embodiment in accordance with the instant disclosure;

FIG. 18 is a top, partial cross-sectional view of a plurality of engine valves in accordance with a fifth embodiment of the instant disclosure;

FIG. 19 is a top, partial cross-sectional view of a plurality of engine valves in accordance with a sixth embodiment of the instant disclosure;

FIGS. 20 and 21 are top, partial cross-sectional views of a plurality of engine valves in accordance with a seventh embodiment of the instant disclosure;

FIGS. 22 and 23 are top, partial cross-sectional views of a plurality of engine valves in accordance with a eighth embodiment of the instant disclosure;

FIG. 24 is a top, partial cross-sectional view of a plurality of engine valves in accordance with a ninth embodiment of the instant disclosure;

FIGS. 25-27 are side views of a plurality of engine valves in accordance with the ninth embodiment of the instant disclosure; and

FIG. 28 is a side view of a main rocker arm in accordance with a tenth embodiment of the instant disclosure.

### DETAILED DESCRIPTION OF THE PRESENT EMBODIMENTS

Reference will now be made in detail to embodiments of the systems and methods of the present invention, examples of which are illustrated in the accompanying drawings. Embodiments of the present invention include systems and methods of actuating one or more engine valves.

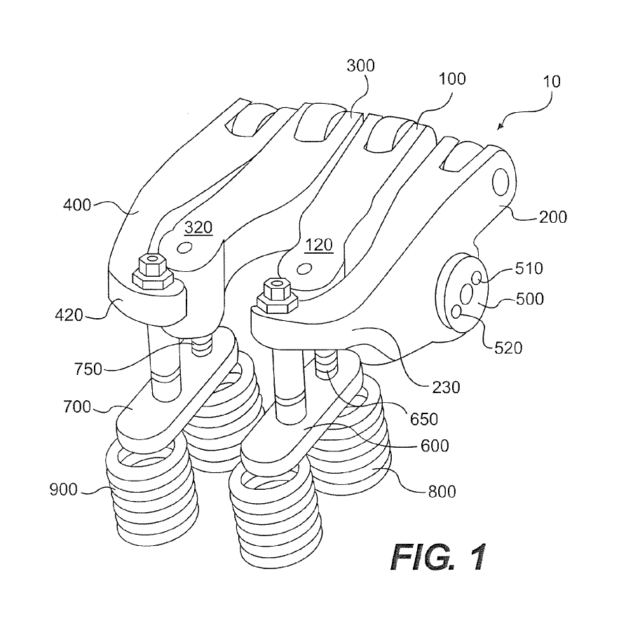

A first embodiment of the present invention is shown in FIG. 1 as valve actuation system 10. The valve actuation system 10 may include a main exhaust rocker arm 200, means for actuating an exhaust valve to provide engine braking 100, a main intake rocker arm 400, and a means for actuating an intake valve to provide engine braking 300. In a preferred embodiment, shown in FIG. 1, the means for actuating an exhaust valve to provide engine braking 100 is an engine braking exhaust rocker arm, referred to by the same reference numeral, and the means for actuating an intake valve to provide engine braking 300 is an engine braking intake rocker arm, referred to by the same reference numeral. The rocker arms 100, 200, 300 and 400 may pivot on one or more rocker shafts 500 which include one or more passages 510 and 520 for providing hydraulic fluid to one or more of the rocker arms.

The main exhaust rocker arm 200 may include a distal end 230 that contacts a center portion of an exhaust valve bridge 600 and the main intake rocker arm 400 may include a distal end 420 that contacts a center portion of an intake valve bridge 700. The engine braking exhaust rocker arm 100 may include a distal end 120 that contacts a sliding pin 650 provided in the exhaust valve bridge 600 and the engine braking intake rocker arm 300 may include a distal end 320 that contacts a sliding pin 750 provided in the intake valve bridge 700. The exhaust valve bridge 600 may be used to actuate two exhaust valve assemblies 800 and the intake valve bridge 700 may be used to actuate two intake valve assemblies 900. Each of the rocker arms 100, 200, 300 and 400 may include ends opposite their respective distal ends which include means for contacting a cam or push tube. Such means may comprise a cam roller, for example.

The cams (described below) that actuate the rocker arms 100, 200, 300 and 400 may each include a base circle portion and one or more bumps or lobes for providing a pivoting motion to the rocker arms. Preferably, the main exhaust rocker arm 200 is driven by a cam which includes a main exhaust bump which may selectively open the exhaust valves during an exhaust stroke for an engine cylinder, and the main intake rocker arm 400 is driven by a cam which includes a main intake bump which may selectively open the intake valves during an intake stroke for the engine cylinder.

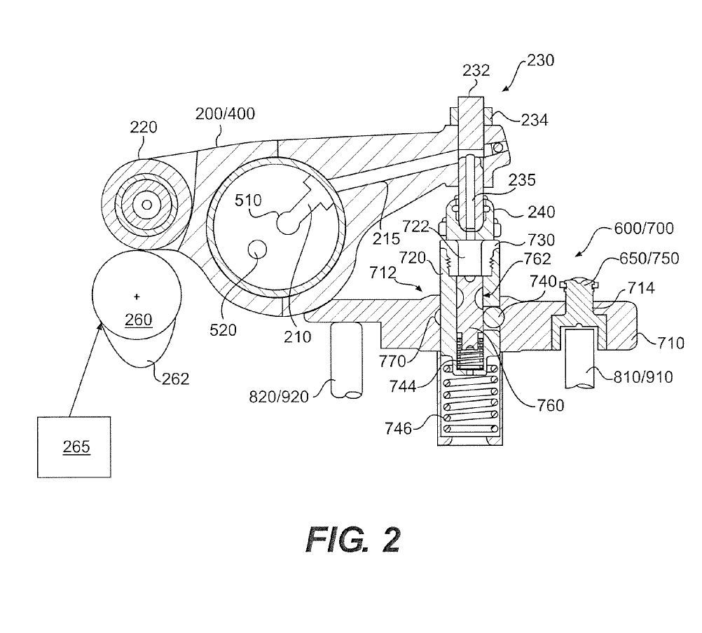

FIG. 2 illustrates the components of the main exhaust rocker arm 200 and main intake rocker arm 400, as well as the exhaust valve bridge 600 and intake valve bridge 700 in cross section. Reference will be made to the main exhaust rocker arm 200 and exhaust valve bridge 600 because it is appreciated the main intake rocker arm 400 and the intake valve bridge 700 may have the same design and therefore need not be described separately.

With reference to FIG. 2, the main exhaust rocker arm 200 may be pivotally mounted on a rocker shaft 210 such that the rocker arm is adapted to rotate about the rocker shaft 210. A motion follower 220 may be disposed at one end of the main exhaust rocker arm 200 and may act as the contact point between the rocker arm and the cam 260 to facilitate low friction interaction between the elements. The cam 260 may include a single main exhaust bump 262, or for the intake side, a main intake bump. In one embodiment of the present invention, the motion follower 220 may comprise a roller follower 220, as shown in FIG. 2. Other embodiments of a motion follower adapted to contact the cam 260 are considered well within the scope and spirit of the present invention. An optional cam phase shifting system 265 may be operably connected to the cam 260.

Hydraulic fluid may be supplied to the rocker arm 200 from a hydraulic fluid supply (not shown) under the control of a solenoid hydraulic control valve (not shown). The hydraulic fluid may flow through a passage 510 formed in the rocker shaft 210 to a hydraulic passage 215 formed within the rocker arm 200. The arrangement of hydraulic passages in the rocker shaft 210 and the rocker arm 200 shown in FIG. 2 are for illustrative purposes only. Other hydraulic arrangements for supplying hydraulic fluid through the rocker arm 200 to the exhaust valve bridge 600 are considered well within the scope and spirit of the present invention.

An adjusting screw assembly may be disposed at a second end 230 of the rocker arm 200. The adjusting screw assembly may comprise a screw 232 extending through the rocker arm 200 which may provide for lash adjustment, and a threaded nut 234 which may lock the screw 232 in place. A hydraulic passage 235 in communication with the rocker passage 215 may be formed in the screw 232. A swivel foot 240 may be disposed at one end of the screw 232. In one embodiment of the present invention, low pressure oil may be supplied to the rocker arm 200 to lubricate the swivel foot 240.

The swivel foot 240 may contact the exhaust valve bridge 600. The exhaust valve bridge 600 may include a valve bridge body 710 having a central opening 712 extending through the valve bridge and a side opening 714 extending through a first end of the valve bridge. The side opening 714 may receive a sliding pin 650 which contacts the valve stem of a first exhaust valve 810. The valve stem of a second exhaust valve 820 may contact the other end of the exhaust valve bridge.

The central opening 712 of the exhaust valve bridge 600 may receive a lost motion assembly including an outer plunger 720, a cap 730, an inner plunger 760, an inner plunger spring 744, an outer plunger spring 746, and one or more wedge rollers or balls 740. The outer plunger 720 may include an interior bore 22 and a side opening extending through the outer plunger wall for receiving the wedge roller or ball 740. The inner plunger 760 may include one or more recesses 762 shaped to securely receive the one or more wedge rollers or balls 740 when the inner plunger is pushed downward. The central opening 712 of the valve bridge 700 may also include one or more recesses 770 for receiving the one or more wedge rollers or balls 740 in a manner that permits the rollers or balls to lock the outer plunger 720 and the exhaust valve bridge together, as shown. The outer plunger spring 746 may bias the outer plunger 740 upward in the central opening 712. The inner plunger spring 744 may bias the inner plunger 760 upward in outer plunger bore 722.

Hydraulic fluid may be selectively supplied from a solenoid control valve, through passages 510, 215 and 235 to the outer plunger 720. The supply of such hydraulic fluid may displace the inner plunger 760 downward against the bias of the inner plunger spring 744. When the inner plunger 760 is displaced sufficiently downward, the one or more recesses 762 in the inner plunger may register with and receive the one or more wedge rollers or balls 740, which in turn may decouple or unlock the outer plunger 720 from the exhaust valve bridge body 710. As a result, during this “unlocked” state, valve actuation motion applied by the main exhaust rocker arm 200 to the cap 730 does not move the exhaust valve bridge body 710 downward to actuate the exhaust valves 810 and 820. Instead, this downward motion causes the outer plunger 720 to slide downward within the central opening 712 of the exhaust valve bridge body 710 against the bias of the outer plunger spring 746.

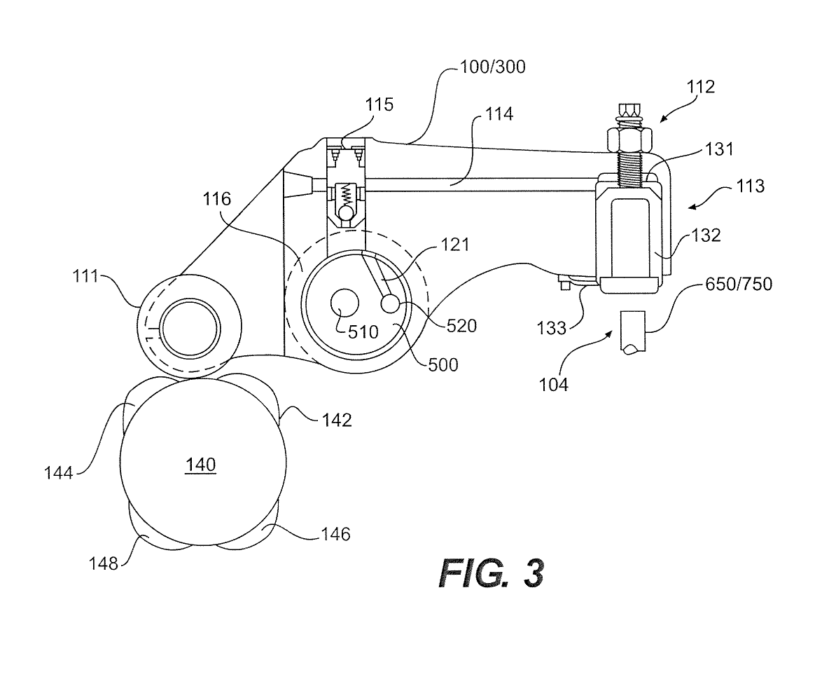

With reference to FIGS. 1 and 3, the engine braking exhaust rocker arm 100 and engine braking intake rocker arm 300 may include lost motion elements such as those provided in the rocker arms illustrated in U.S. Pat. Nos. 3,809,033 and 6,422,186, which are hereby incorporated by reference. The engine braking exhaust rocker arm 100 and engine braking intake rocker arm 300 may each have a selectively extendable actuator piston 132 which may take up a lash space 104 between the extendable actuator pistons and the sliding pins 650 and 750 provided in the valve bridges 600 and 700 underlying the engine braking exhaust rocker arm and engine braking intake rocker arm, respectively.

With reference to FIG. 3, the rocker arms 100 and 300 may have the same constituent parts and thus reference will be made to the elements of the exhaust side engine braking rocker arm 100 for ease of description.

A first end of the rocker arm 100 may include a cam lobe follower 111 which contacts a cam 140. The cam 140 may have one or more bumps 142, 144, 146 and 148 to provide compression release, brake gas recirculation, exhaust gas recirculation, and/or partial bleeder valve actuation to the exhaust side engine braking rocker arm 100. When contacting an intake side engine braking rocker arm 300, the cam 140 may have one, two, or more bumps to provide one, two or more intake events to an intake valve. The engine braking rocker arms 100 and 300 may transfer motion derived from cams 140 to operate at least one engine valve each through respective sliding pins 650 and 750.

The exhaust side engine braking rocker arm 100 may be pivotally disposed on the rocker shaft 500 which includes hydraulic fluid passages 510, 520 and 121. The hydraulic passage 121 may connect the hydraulic fluid passage 520 with a port provided within the rocker arm 100. The exhaust side engine braking rocker arm 100 (and intake side engine braking rocker arm 300) may receive hydraulic fluid through the rocker shaft passages 520 and 121 under the control of a solenoid hydraulic control valve (not shown). It is contemplated that the solenoid control valve may be located on the rocker shaft 500 or elsewhere.

The engine braking rocker arm 100 may also include a control valve 115. The control valve 115 may receive hydraulic fluid from the rocker shaft passage 121 and is in communication with the fluid passageway 114 that extends through the rocker arm 100 to the lost motion piston assembly 113. The control valve 115 may be slidably disposed in a control valve bore and include an internal check valve which only permits hydraulic fluid flow from passage 121 to passage 114. The design and location of the control valve 115 may be varied without departing from the intended scope of the present invention. For example, it is contemplated that in an alternative embodiment, the control valve 115 may be rotated approximately 90° such that its longitudinal axis is substantially aligned with the longitudinal axis of the rocker shaft 500.

A second end of the engine braking rocker arm 100 may include a lash adjustment assembly 112, which includes a lash screw and a locking nut. The second end of the rocker arm 100 may also include a lost motion piston assembly 113 below the lash adjuster assembly 112. The lost motion piston assembly 113 may include an actuator piston 132 slidably disposed in a bore 131 provided in the head of the rocker arm 100. The bore 131 communicates with fluid passage 114. The actuator piston 132 may be biased upward by a spring 133 to create a lash space between the actuator piston and the sliding pin 650. The design of the lost motion piston assembly 113 may be varied without departing from the intended scope of the present invention.

Application of hydraulic fluid to the control valve 115 from the passage 121 may cause the control valve to index upward against the bias of the spring above it, as shown in FIG. 3, permitting hydraulic fluid to flow to the lost motion piston assembly 113 through passage 114. The check valve incorporated into the control valve 115 prevents the backward flow of hydraulic fluid from passage 114 to passage 121. When hydraulic fluid pressure is applied to the actuator piston 131, it may move downward against the bias of the spring 133 and take up any lash space between the actuator piston and the sliding pin 650. In turn, valve actuation motion imparted to the engine braking rocker arm 100 from the cam bumps 142, 144, 146 and/or 148 may be transferred to the sliding pin 650 and the exhaust valve 810 below it. When hydraulic pressure is reduced in the passage 121 under the control of the solenoid control valve (not shown), the control valve 115 may collapse into its bore under the influence of the spring above it. Consequently, hydraulic pressure in the passage 114 and the bore 131 may be vented past the top of the control valve 115 to the outside of the rocker arm 100. In turn, the spring 133 may force the actuator piston 132 upward so that the lash space 104 is again created between the actuator piston and the sliding pin 650. In this manner, the exhaust and intake engine braking rocker arms 100 and 300 may selectively provide valve actuation motions to the sliding pins 650 and 750, and thus, to the engine valves disposed below these sliding pins.

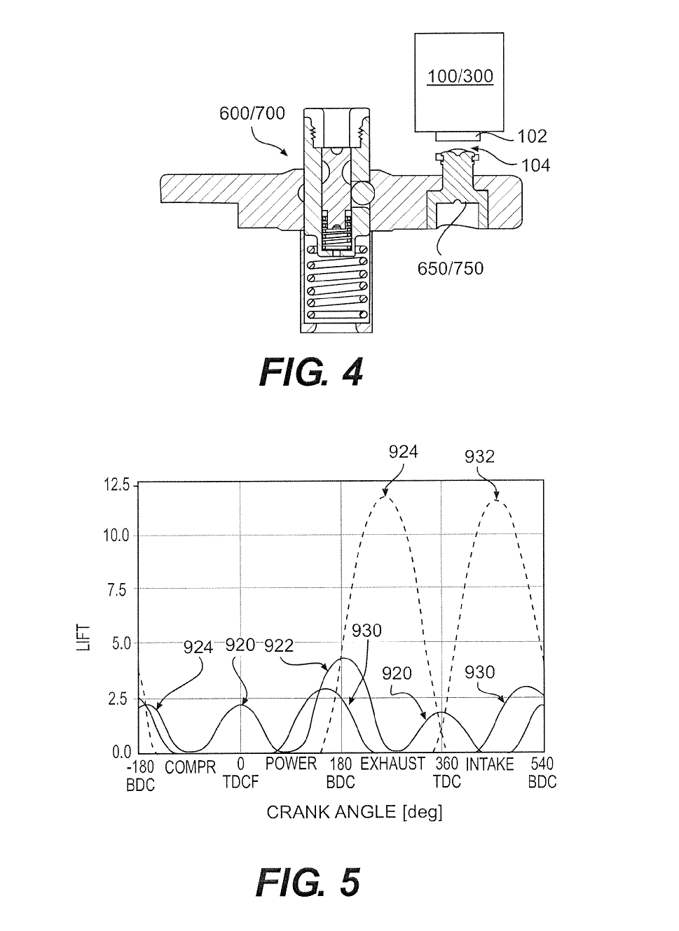

With reference to FIG. 4, in another alternative embodiment of the present invention, it is contemplated that the means for actuating an exhaust valve to provide engine braking 100, and/or the means for actuating an intake valve to provide engine braking 300 may be provided by any lost motion system, or any variable valve actuation system, including without limitation, a non-hydraulic system which includes an actuator piston 102. A lash space 104 may be provided between the actuator piston 102 and the underlying sliding pin 650/750, as described above. The lost motion or variable valve actuation system 100/300 may be of any type known to be capable of selectively actuating an engine valve.

The operation of the engine braking rocker arm 100 will now be described. During positive power, the solenoid hydraulic control valve which selectively supplies hydraulic fluid to the passage 121 is closed. As such, hydraulic fluid does not flow from the passage 121 to the rocker arm 100 and hydraulic fluid is not provided to the lost motion piston assembly 113. The lost motion piston assembly 113 remains in the collapsed position illustrated in FIG. 3. In this position, the lash space 104 may be maintained between the lost motion piston assembly 113 and the sliding pin 650/750.

During engine braking, the solenoid hydraulic control valve may be activated to supply hydraulic fluid to the passage 121 in the rocker shaft. The presence of hydraulic fluid within fluid passage 121 causes the control valve 115 to move upward, as shown, such that hydraulic fluid flows through the passage 114 to the lost motion piston assembly 113. This causes the lost motion piston 132 to extend downward and lock into position taking up the lash space 104 such that all movement that the rocker arm 100 derives from the one or more cam bumps 142, 144, 146 and 148 is transferred to the sliding pin 650/750 and to the underlying engine valve.

With reference to FIGS. 2, 3 and 5, in a first method embodiment, the system 10 may be operated as follows to provide positive power and engine braking operation. During positive power operation (brake off), hydraulic fluid pressure is first decreased or eliminated in the main exhaust rocker arm 200 and next decreased or eliminated in the main intake rocker arm 400 before fuel is supplied to the cylinder. As a result, the inner plungers 760 are urged into their upper most positions by the inner plunger springs 744, causing the lower portions of the inner plungers to force the one or more wedge rollers or balls 740 into the recesses 770 provided in the walls of the valve bridge bodies 710. This causes the outer plungers 720 and the valve bridge bodies 710 to be “locked” together, as shown in FIG. 2. In turn, the main exhaust and main intake valve actuations that are applied through the main exhaust and main intake rocker arms 200 and 400 to the outer plungers 720 are transferred to the valve bridge bodies 710 and, in turn the intake and exhaust engine valves are actuated for main exhaust and main intake valve events.

During this time, decreased or no hydraulic fluid pressure is provided to the engine braking exhaust rocker arm 100 and the engine braking intake rocker arm 300 (or the means for actuating an exhaust valve to provide engine braking 100 and means for actuating an intake valve to provide engine braking 300) so that the lash space 104 is maintained between each said rocker arm or means and the sliding pins 650 and 750 disposed below them. As a result, neither the engine braking exhaust rocker arm or means 100 nor the engine braking intake rocker arm or means 300 imparts any valve actuation motion to the sliding pins 650 and 750 or the engine valves 810 and 910 disposed below these sliding pins.

During engine braking operation, after ceasing to supply fuel to the engine cylinder and waiting a predetermined time for the fuel to be cleared from the cylinder, increased hydraulic fluid pressure is provided to each of the rocker arms or means 100, 200, 300 and 400. Hydraulic fluid pressure is first applied to the main intake rocker arm 400 and engine braking intake rocker arm or means 300, and then applied to the main exhaust rocker arm 200 and engine braking exhaust rocker arm or means 100.

Application of hydraulic fluid to the main intake rocker arm 400 and main exhaust rocker arm 200 causes the inner plungers 760 to translate downward so that the one or more wedge rollers or balls 740 may shift into the recesses 762. This permits the inner plungers 760 to “unlock” from the valve bridge bodies 710. As a result, main exhaust and intake valve actuation that is applied to the outer plungers 720 is lost because the outer plungers slide into the central openings 712 against the bias of the springs 746. This causes the main exhaust and intake valve events to be “lost.”

The application of hydraulic fluid to the engine braking exhaust rocker arm 100 (or means for actuating an exhaust valve to provide engine braking 100) and the engine braking intake rocker arm 300 (or means for actuating an intake valve to provide engine braking 300) causes the actuator piston 132 in each to extend downward and take up any lash space 104 between those rocker arms or means and the sliding pins 650 and 750 disposed below them. As a result, the engine braking valve actuations applied to the engine braking exhaust rocker arm or means 100 and the engine braking intake rocker arm or means 300 are transmitted to the sliding pins 650 and 750, and the engine valves below them.

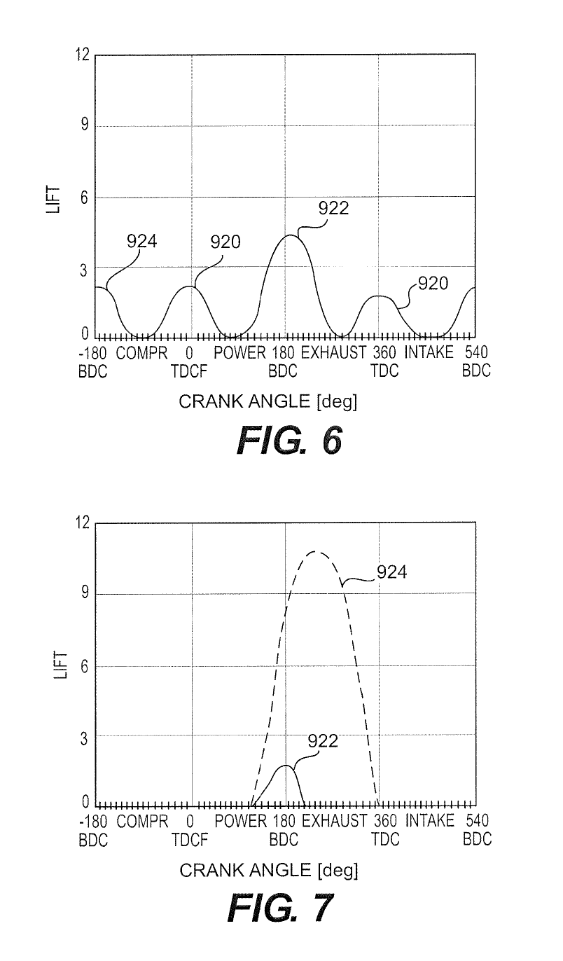

FIG. 5 illustrates the intake and exhaust valve actuations that may be provided using a valve actuation system 10 that includes a main exhaust rocker arm 200, means for actuating an exhaust valve to provide engine braking 100, a main intake rocker arm 400, and a means for actuating an intake valve to provide engine braking 300, operated as described directly above. The main exhaust rocker arm 200 may be used to provide a main exhaust event 924, and the main intake rocker arm 400 may be used to provide a main intake event 932 during positive power operation.

During engine braking operation, the means for actuating an exhaust valve to provide engine braking 100 may provide a standard BGR valve event 922, an increased lift BGR valve event 924, and two compression release valve events 920. The means for actuating an intake valve to provide engine braking 300 may provide two intake valve events 930 which provide additional air to the cylinder for engine braking. As a result, the system 10 may provide full two-cycle compression release engine braking.

With continued reference to FIG. 5, in a first alternative, the system 10 may provide only one or the other of the two intake valve events 930 as a result of employing a variable valve actuation system to serve as the means for actuating an intake valve to provide engine braking 300. The variable valve actuation system 300 may be used to selectively provide only one or the other, or both intake valve events 930. If only one of such intake valve events is provided, 1.5-cycle compression release engine braking results.

In another alternative, the system 10 may provide only one or the other of the two compression release valve events 920 and/or one, two or none of the BGR valve events 922 and 924 as a result of employing a variable valve actuation system to serve as the means for actuating an exhaust valve to provide engine braking 100. The variable valve actuation system 100 may be used to selectively provide only one or the other, or both compression release valve events 920 and/or none, one or two of the BGR valve events 922 and 924. When the system 10 is configured in this way, it may selectively provide 4-cycle or 2-cycle compression release engine braking with or without BGR.

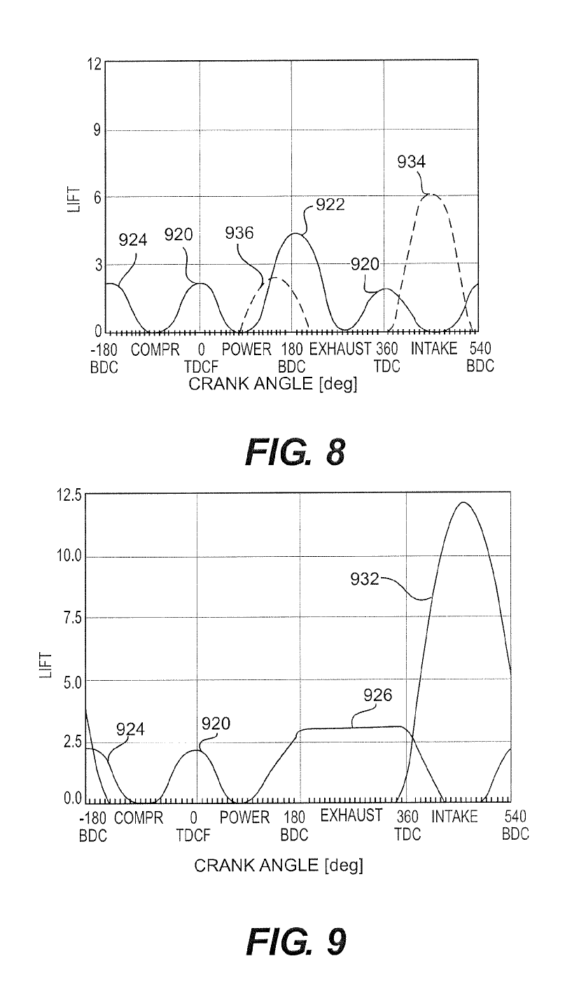

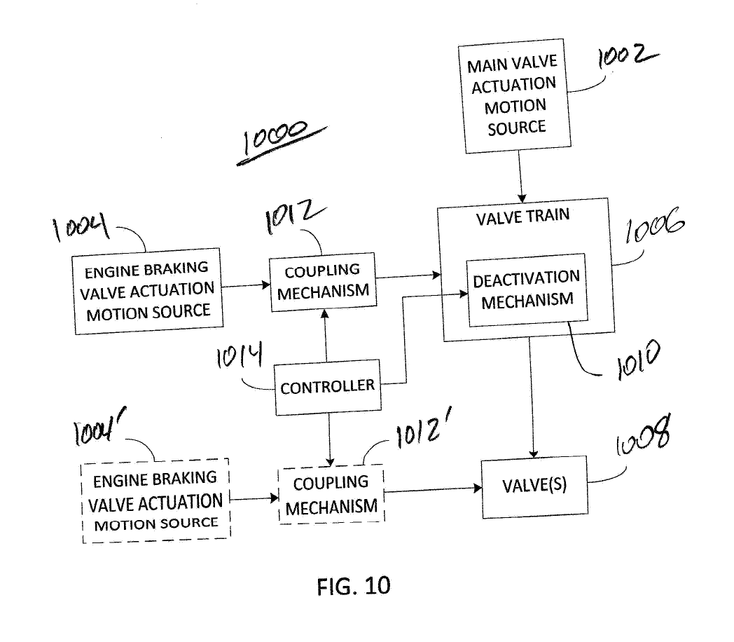

The significance of the inclusion of the increased lift BGR valve event 922, which is provided by having a corresponding increased height cam lobe bump on the cam driving the means for actuating an exhaust valve to provide engine braking 100, is illustrated by FIGS. 6 and 7. With reference to FIGS. 3, 4 and 6, the height of the cam bump that produces the increased lift BGR valve event 922 exceeds the magnitude of the lash space provided between the means for actuating an exhaust valve to provide engine braking 100 and the sliding pin 650. This increased height or lift is evident from event 922 in FIG. 6 as compared with events 920 and 924. During reinstitution of positive power operation using the system 10, it is possible that the exhaust valve bridge 600 will fail to lock to the outer plunger 720, which would ordinarily result in the loss of a main exhaust event 924, which in turn could cause severe engine damage. With reference to FIG. 7, by including the increased lift BGR valve event 922, if the main exhaust event 924 is lost due to a failure, the increased lift BGR valve event 922 will permit exhaust gas to escape from the cylinder near in time to the time that the normally expected main exhaust valve event 924 was supposed to occur, and prevent engine damage that might otherwise result.

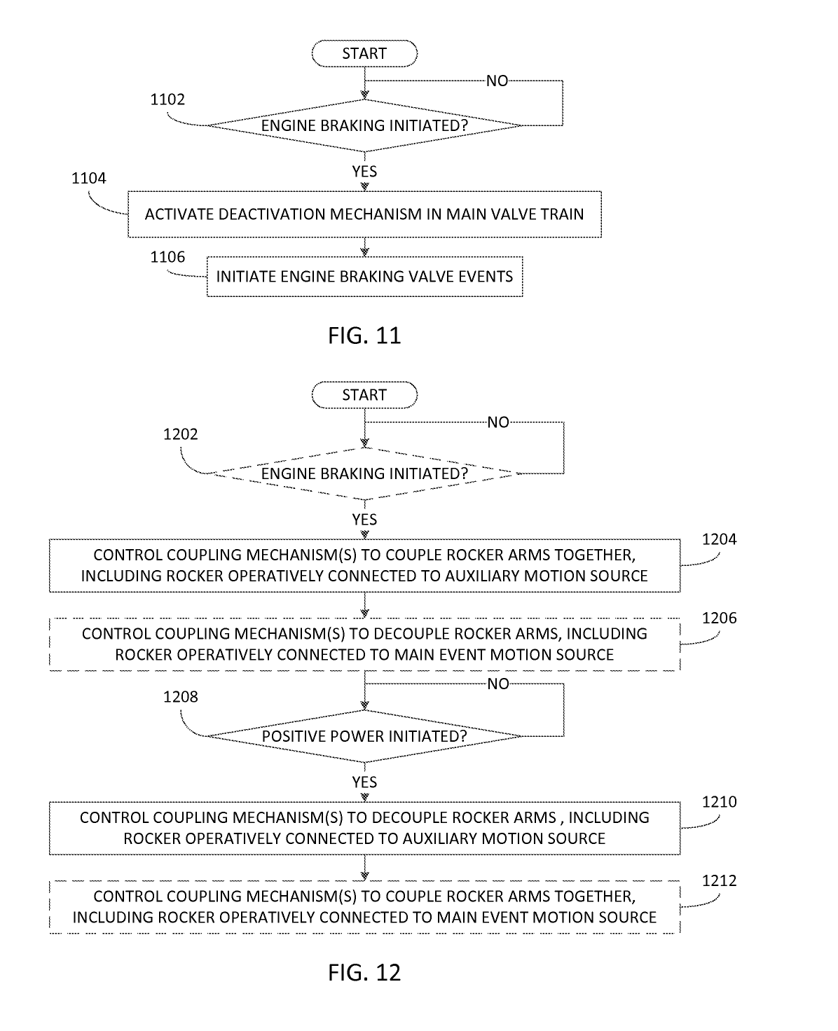

An alternative set of valve actuations, which may be achieved using one or more of the systems 10 describe above, are illustrated by FIG. 8. With reference to FIG. 8, the system used to provide the exhaust valve actuations 920, 922 and 924 are the same as those described above, and the manner of actuating the main exhaust rocker arm 200 and the engine braking exhaust rocker arm 100 (FIG. 3) or means for actuating an exhaust valve to provide engine braking 100 (FIG. 4) are also the same. The main intake rocker arm 400 and manner of operating it are similarly the same as in the previous embodiments.

With continued reference to FIG. 8, one, or the other, or both of the intake valve events 934 and/or 936 may be provided using one of three alternative arrangements. In a first alternative, the means for actuating an intake valve to provide engine braking 300, whether provided as rocker arm or otherwise, may be eliminated from the system 10. With additional reference to FIG. 2, in place of means 300, an optional cam phase shifting system 265 may be provided to operate on the cam 260 driving the main intake rocker arm 400. The cam phase shifting system 265 may selectively modify the phase of the cam 260 with respect to the crank angle of the engine. As a result, with reference to FIGS. 2 and 8, the intake valve event 934 may be produced from the main intake cam bump 262. The intake valve event 934 may be “shifted” to occur later than it ordinarily would occur. Specifically, the intake valve event 934 may be retarded so as not to interfere with the second compression release valve event 920. Intake valve event 936 may not be provided when the cam phase shifting system 265 is utilized, which results in 1.5-cycle compression release engine braking.

Instituting compression release engine braking using a system 10 that includes a cam phase shifting system 265 may occur as follows. First, fuel is shut off to the engine cylinder in question and a predetermined delay is provided to permit fuel to clear from the cylinder. Next, the cam phase shifting system 265 is activated to retard the timing of the main intake valve event. Finally, the exhaust side solenoid hydraulic control valve (not shown) may be activated to supply hydraulic fluid to the main exhaust rocker arm 200 and the means for actuating an exhaust valve to provide engine braking 100. This may cause the exhaust valve bridge body 710 to unlock from the outer plunger 720 and disable main exhaust valve events. Supply of hydraulic fluid to the means for actuating an exhaust valve to provide engine braking 100 may produce the engine braking exhaust valve events, including one or more compression release events and one or more BGR events, as explained above. This sequence may be reversed to transition back to positive power operation starting from an engine braking mode of operation.

With reference to FIGS. 4 and 8, in second and third alternatives, one, or the other, or both of the intake valve events 934 and/or 936 may be provided by employing a lost motion system or a variable valve actuation system to serve as the means for actuating an intake valve to provide engine braking 300. A lost motion system may selectively provide both intake valve events 934 and 936, while a variable valve actuation system may selectively provide one, or the other, or both intake valve events 934 and 936.

Instituting compression release engine braking using a system 10 that includes a hydraulic lost motion system or hydraulic variable valve actuation system may occur as follows. First, fuel is shut off to the engine cylinder in question and a predetermined delay is incurred to permit fuel to clear from the cylinder. Next, the intake side solenoid hydraulic control valve may be activated to supply hydraulic fluid to the main intake rocker arm 400 and the intake valve bridge 700. This may cause the intake valve bridge body 710 to unlock from the outer plunger 720 and disable main intake valve events. Finally, the exhaust side solenoid hydraulic control valve may be activated to supply hydraulic fluid to the main exhaust rocker arm 200 and the means for actuating an exhaust valve to provide engine braking 100. This may cause the exhaust valve bridge body 710 to unlock from the outer plunger 720 and disable the main exhaust valve event. Supply of hydraulic fluid to the means for actuating an exhaust valve to provide engine braking 100 may produce the desired engine braking exhaust valve events, including one or more compression release valve events 920, and one or more BGR valve events 922 and 924, as explained above. This sequence may be reversed to transition back to positive power operation starting from an engine braking mode of operation.

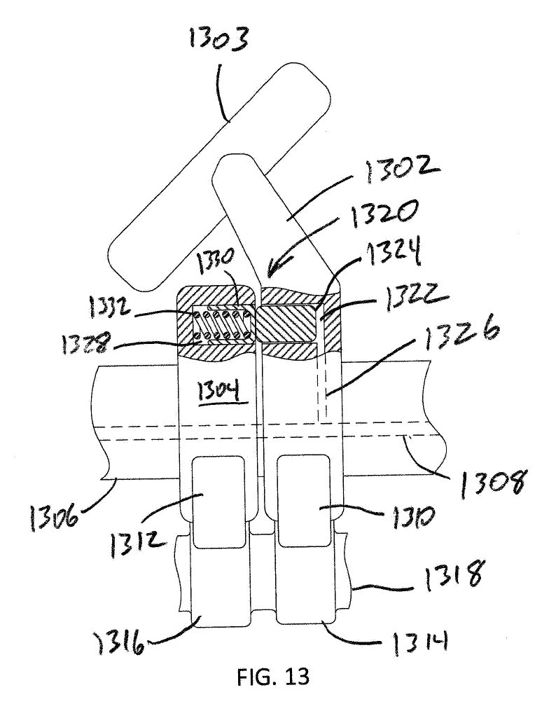

Another alternative to the methods described above is illustrated by FIG. 9. In FIG. 9 all valve actuations shown are the same as described above, and may be provided using any of the systems 10 described above, with one exception. Partial bleeder exhaust valve event 926 (FIG. 9) replaces BGR valve event 922 and compression release valve event 920 (FIGS. 5 and 8). This may be accomplished by including a partial bleeder cam bump on the exhaust cam in place of the two cam bumps that would otherwise produce the BGR valve event 922 and the compression release valve event 920.

It is also appreciated that any of the foregoing discussed embodiments may be combined with the use of a variable geometry turbocharger, a variable exhaust throttle, a variable intake throttle, and/or an external exhaust gas recirculation system to modify the engine braking level achieved using the system 10. In addition, the engine braking level may be modified by grouping one or more valve actuation systems 10 in an engine together to receive hydraulic fluid under the control of a single solenoid hydraulic control valve. For example, in a six cylinder engine, three sets of two intake and/or exhaust valve actuation systems 10 may be under the control of three separate solenoid hydraulic control valves, respectively. In such a case, variable levels of engine braking may be provided by selectively activating the solenoid hydraulic control valves to provide hydraulic fluid to the intake and/or exhaust valve actuation systems 10 to produce engine braking in two, four, or all six engine cylinders.

It will be apparent to those skilled in the art that variations and modifications of the above-described embodiments can be made. For example, the means for actuating an exhaust valve to provide engine braking 100 and the means for actuating an intake valve to provide engine braking 300 may provide non-engine braking valve actuations in other applications. Furthermore, the apparatus shown to provide the means for actuating an exhaust valve to provide engine braking 100 and the means for actuating an intake valve to provide engine braking 300 may be provided by apparatus other than that shown in FIGS. 3 and 4.

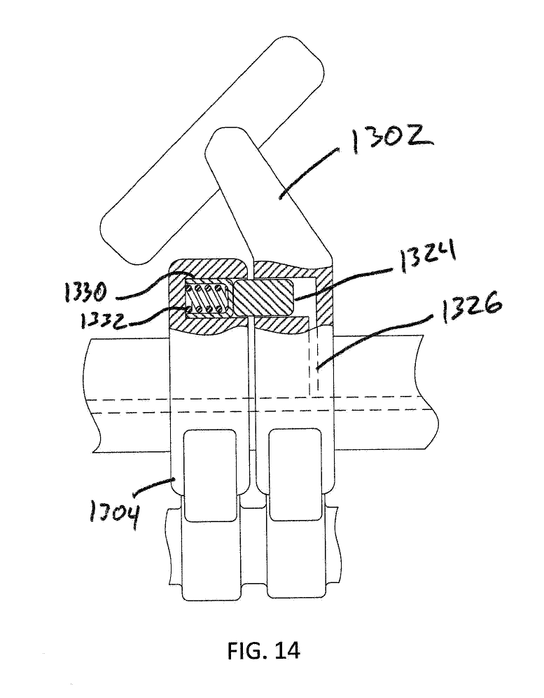

FIG. 10 is a block diagram schematically illustrating a valve actuation system in accordance with the various embodiments of the instant disclosure. In particular the system 1000 comprises a main valve actuation motion source 1002 and an auxiliary valve actuation motion source 1004. As used herein the terms “main” or “main event” or variants thereof are used hereinbelow to refer to those components pertaining to singular valve motions or such singular valve motions for intake and exhaust valves required for positive power operation of an internal combustion engine, i.e., exhaust main events or intake main events. Further, as used hereinbelow the terms “auxiliary” or “auxiliary motion” or variants therefore refer to those components pertaining to valve motions or such valve motions associated with operation of an internal combustion engine other than main events, and may include valve motions that are not required for positive power generation but that may be used in conjunction with such operation as well as valve motions that are not compatible with positive power generation. By way of non-limiting example, auxiliary valve motions that are distinguished from main valve events include valve events such as compression release (CR) valve motion, brake gas recirculation (BGR), internal exhaust gas recirculation (IEGR) on intake or exhaust, early valve (EVO) opening through addition of supplementary valve event(s) to the main event, late valve closing (LVC) through addition of supplementary valve event(s) during the closing of the main valve event, additional valve events to modify the air motion in cylinder and valve events to excite turbochargers. U.S. Pat. Nos. 6,325,043; 6,827,067; 7,712,449; 8,375,904 and U.S. Patent Application Publication No. 2005/0274341 teach various auxiliary valve motions, the teachings of which publications are incorporated herein by this reference. However, as will be evident from the description herein, such auxiliary components or valve motions may cooperate with main components, and vice versa, in order to achieve the desired operation. As a subset of “auxiliary,” the terms “braking,” “braking motion,” “braking events” or variants thereof are used hereinbelow to refer to those components or valve motions associated with engine braking operation of an internal combustion engine. For example, braking valve motions or engine braking valve motions refer to, for example, CR valve motions, bleeder valve motions, brake gas recirculation BGR valve motions, etc. as known in the art. Thus, the main valve actuation motion source 1002 provides main valve events or motions to be conveyed to one or more engine valves 1008 and, likewise, the auxiliary valve actuation motion source 1004 provides auxiliary valve events or motions to be conveyed to the one or more engine valves 1008. Each of the main valve actuation motion source 1002 and auxiliary valve actuation motion source 1004 may comprise any of a number of known motion sources known in the art, e.g., a rotating cam (such as cams 260, 140 described above), a pushrod and/or tappet in connection with a rotating cam, etc., configured to provide the requisite valve motions.

The main valve actuation motion source 1002 is operatively connected to a main valve train 1006 that, in turn, is operatively connected to the one or more engine valves 1008. The one or more engine valves 1008 may comprise any type of engine valve such as intake or exhaust valves, as known in the art. Likewise, as known in the art, the main valve train 1006 may comprise one or more components used to convey motion from the main valve actuation motion source 1002 to the valve(s) 1008. For example, the main valve train 1006 may comprise a linkage of one or more of a rocker arm, pushrod, tappet, lash adjuster, valve bridge or other components known in the art for conveying motions to valves. In the illustrated embodiment, the main valve train 1006 further comprises a deactivation mechanism 1010 that may be activated to disable conveyance of main valve motions to the valve(s) 1008. Thus, the deactivation mechanism 1010 is a lost motion device as described above, an example of which is the lost motion assembly illustrated in FIG. 2 constituted by the outer plunger 720, cap 730, inner plunger 760, inner plunger spring 744, outer plunger spring 746, and balls 740.

While the embodiment of FIG. 2 is an example of a hydraulically actuated locking mechanism residing in a valve bridge 600, 700, those having skill in the art will appreciate that any of a number of different deactivation mechanisms configured for placement at various points along the main valve train 1006 may be used. For example, hydraulically or electrically collapsible mechanisms such as valve lifters or tappets may change lengths to make or break contact with a cam, an example of which is the so-called Displacement On Demand technology employed in some General Motors vehicles. Alternatively, selectable rocker arms, through hydraulic circuits provided in a rocker arm shaft, may be used to activate and deactivate rocker arms, examples of which include Honda's Variable Valve Timing and Lift Electronic Control (VTEC) system, the Nissan Ecology Oriented Variable Valve Lift and Timing (NEO VVL) system or the radial locking pin implementation disclosed in U.S. Pat. No. 5,099,806. In another alternative, hydraulically controlled lost motion mechanisms may be incorporated into a rocker arm, an example of which includes the so-called Variable Valve Timing with intelligence (VVT-i) system by Toyota.

Further implementations of the deactivation mechanism 1010 based on the coupling and/or decoupling of adjacent rocker arms are described in detail below.

As further shown, the auxiliary valve actuation motion source 1004 may be operatively connected to the valve(s) 1008 via a coupling mechanism 1012 and at least a portion of the main valve train 1006. For example, as described below, the coupling mechanism 1012 may comprise one or more sliding pins and related components that permit adjacent rocker arms to be selectively coupled or decoupled, thereby causing motions conveyed by one rocker arm to be passed to another rocker arm. In an alternate embodiment, as illustrated by the dashed lines, the auxiliary valve actuation motion source 1004′ and coupling mechanism 1012′ may bypass the main valve train 1006 and instead be directed connected to the valve(s) 1008. An example of this alternate embodiment is illustrated in FIG. 3 where the lost motion piston assembly 113 may be activated to contact the sliding pin 650, 750 such that braking valve motions imparted by the cam 140 are conveyed by the engine braking rocker arm 100, 300 to the sliding pin 650, 750 and the corresponding valve.

Finally, FIG. 10 illustrates a controller 1014 that may be used to control operation of the deactivation mechanism 1010 and/or the coupling mechanism 1012, 1012′. In an embodiment, the controller 1014 may comprise a processing device such as a microprocessor, microcontroller, digital signal processor, co-processor or the like or combinations thereof capable of executing stored instructions, or programmable logic arrays or the like, as embodied, for example, in an engine control unit (ECU). Although not illustrated in FIG. 10, the controller 1014 may include one or more switched controls, e.g., solenoids, relays, etc., that may be used to effectuate control of the deactivation mechanism 1010 and/or the coupling mechanism 1012, 1012′. For example, in one embodiment, the controller 140 may be coupled to a user input device (e.g., a switch, not shown) through which a user may be permitted to activate a desired auxiliary valve motion mode of operation. Detection by the controller 1014 of selection of the user input device may then cause the controller 1014 to provide the necessary signals to activate or deactivate the deactivation mechanism 1010 and/or the coupling mechanism 1012, 1012′. Alternatively, or additionally, the controller 1014 may be coupled to one or more sensors (not shown) that provide data used by the controller 140 to determine how to control the deactivation mechanism 1010 and/or the coupling mechanism 1012, 1012′. In an embodiment, particularly applicable where the deactivation mechanism 1010 and/or the coupling mechanism 1012, 1012′ is an hydraulically enabled device, a suitable switched control may comprise one or more solenoids used to control the flow of an hydraulic fluid, such as engine oil, from a pressurized fluid supply (not shown). As known in the art, each cylinder of a multi-cylinder internal combustion engine may have its own switched control uniquely associated therewith in the sense that operation of the switched controls is applied only to the deactivation mechanism 1010 and/or the coupling mechanism 1012, 1012′ associated with that cylinder. In an alternate embodiment, common or global switched controls may be optionally used instead, in which case operation of the switched control(s) services multiple cylinders.

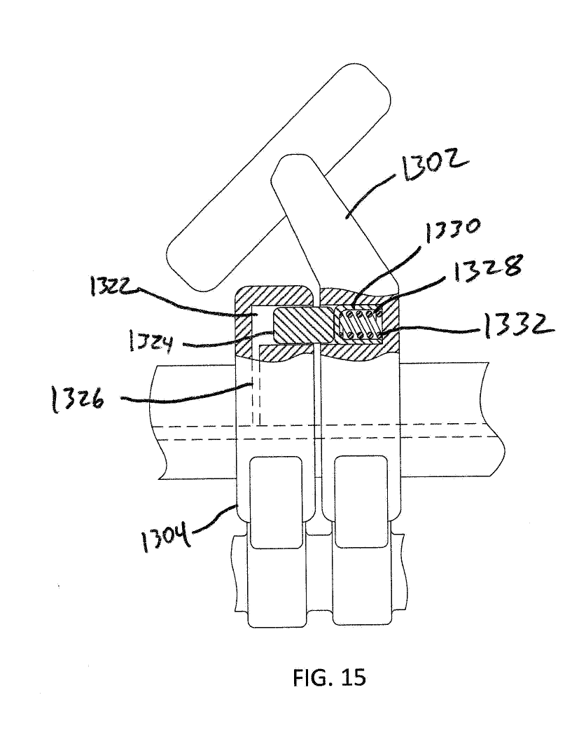

In accordance with the system 1000, a method for performing auxiliary valve motions is further illustrated in FIG. 11. In an embodiment, the process illustrated in FIG. 11 may be carried out by the controller 1014 through control of the deactivation mechanism 1010 and/or the coupling mechanism 1012, 1012′. Thus, at block 1102, a determination is made whether engine braking operation has been initiated. As described above, such a determination may be made through detection of suitable user-based and/or sensor-based input. Regardless, once it is determined that engine braking operation has been initiated, processing continues at block 1104 where the deactivation mechanism 1010 is activated thereby disabling conveyance of main valve events from the main valve actuation motion source 1002 to the valve(s) 1008. Additionally, at block 1106, and again in response to the determination that engine braking operation has been initiated, engine braking valve events are enabled for the valve(s) 1008. In the context of the system 1000, this may comprise activating the coupling mechanism 1012, 1012′. As described above, the activation of the deactivation mechanism 1010 and/or coupling mechanism 1012, 1012′ may be accomplished through hydraulic or electrical switched controls. In one embodiment, the engine braking valve events may comprise two-stroke engine braking as described above relative to FIG. 5.

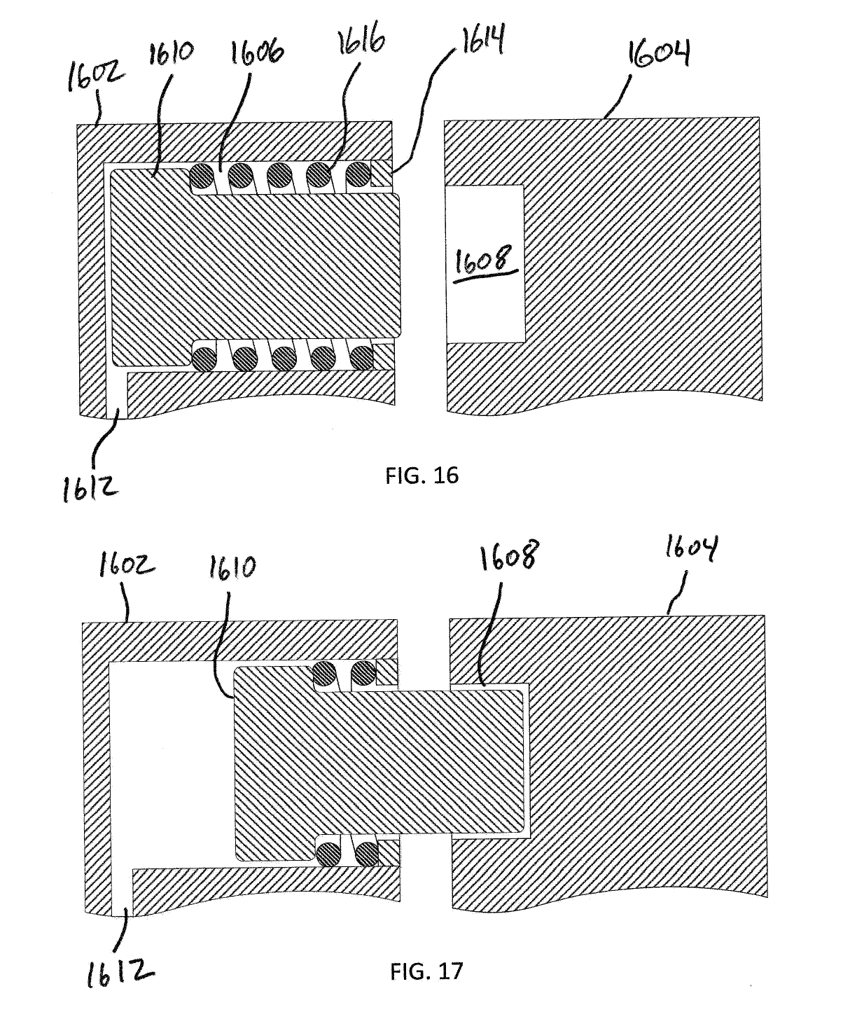

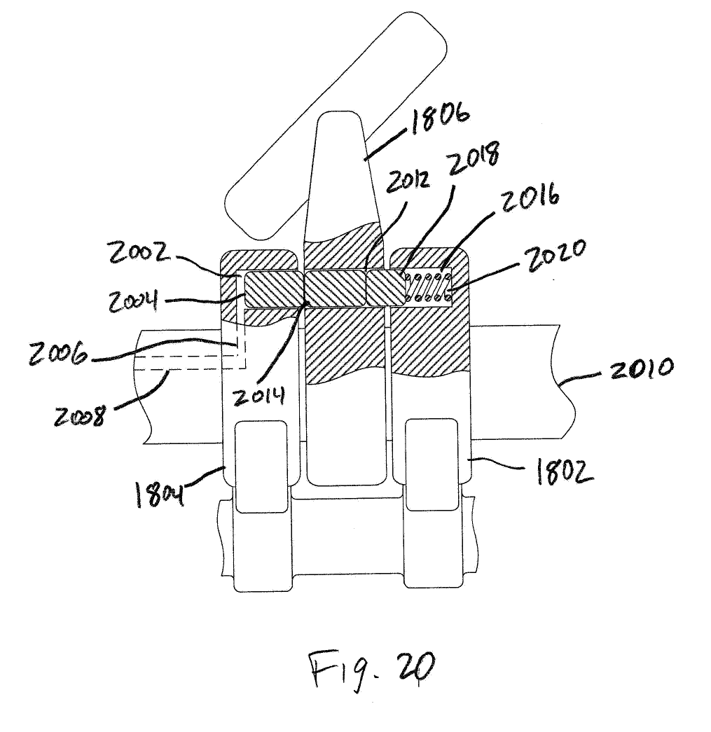

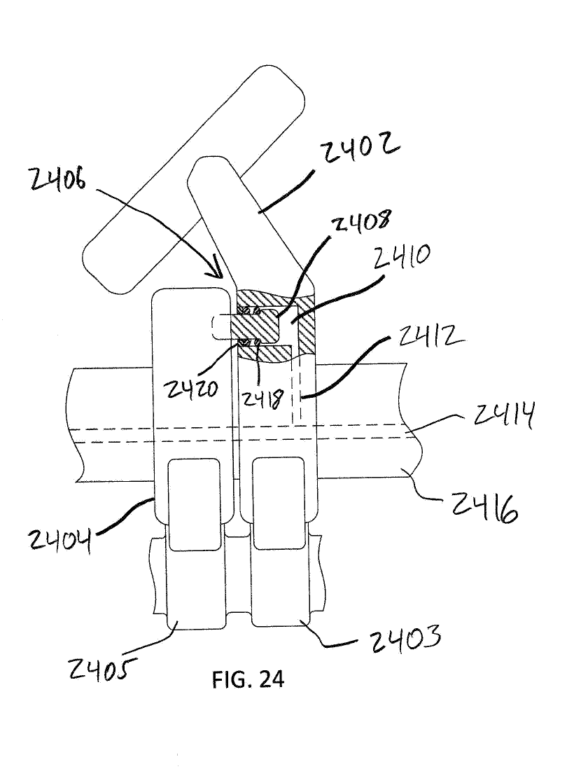

Referring now to FIGS. 13-28, various embodiments of a system incorporating a plurality of rocker arms, which rocker arms may be selectively coupled and decoupled from each other, are illustrated. Each of the embodiments illustrated in FIGS. 13-28 include features of one or more coupling mechanisms that may be used to couple/decouple adjacent rocker arms. In particular, each pair of adjacent rocker arms defines a boundary therebetween, and a coupling mechanism is provided for each such boundary. Thus, in the embodiments illustrated in FIGS. 13-15 and 24, two adjacent rocker arms and a single coupling mechanism are illustrated, whereas, in the embodiments illustrated in FIGS. 18-23, three rocker arms and two coupling mechanisms are illustrated. Additionally, FIGS. 24-28 illustrate examples of one-way coupling mechanisms between adjacent rocker arms. Regardless of the implementation, the embodiments illustrated in FIGS. 13-28 may be used to provide auxiliary valve motions generally, and engine braking valve motions in particular, to one or more valves as described in greater detail below.

Referring now to FIG. 12, a method for performing auxiliary valve motions based on the embodiments of FIGS. 13-28 is illustrated. Once again, in an embodiment, the process illustrated in FIG. 12 may be carried out by a controller (such as controller 1014) through control of the various coupling mechanisms illustrated in FIGS. 13-28 and described in further detail below.

As noted above, the braking valve motions employed in engine braking operation may be considered a subset of auxiliary valve motions. Thus, the dashed lines of block 1202 indicate its status as an optional step to the extent that a determination is made whether engine braking operation has been initiated, techniques for which determination have been explained above. More generally, it can be assumed that the process illustrated in FIG. 12 is performed in those instances where some form of auxiliary valve motion is desired, which auxiliary valve motion may include the specific subset of engine braking valve motions. Thus, regardless of the nature of the auxiliary valve motion to be implemented, processing continues at block 1204 where one or more coupling mechanisms are controlled to couple a first rocker arm to a second rocker arm, the first rocker arm being operatively connected to at least one valve and the second rocker arm being operatively connected to an auxiliary motion source. Coupled in this manner, the auxiliary valve motions provided by the auxiliary motion source may be coupled into the first rocker arm by virtue of its coupling with the second rocker arm. It is noted that, in this case, the auxiliary valve motions thus imparted on the first rocker arm may be in addition to any other valve motions applied to the first rocker arm (e.g., main valve motions) or may be the sole valve motions applied to the first rocker arm. In the event that the first rocker arm is already operatively connected to a main event motion source through coupling with a third rocker arm (as may the case, for example, in the implementations illustrated in FIGS. 18-24), processing may optionally include block 1206 where one or more control mechanisms are controlled to decouple the first rocker arm from a third rocker arm, the third rocker arm being operatively connected to a main event motion source. It is noted that, although blocks 1204 and 1206 are illustrated in FIG. 12 in a particular order, this is not a requirement and the operations performed in these blocks may be reversed according to the particular needs of a given application. The ability to discontinue main event motions from being applied to the first rocker arm, while simultaneously being able to apply auxiliary valve motions to the first rocker arm via the second rocker arm, permits particular engine braking operations to be implemented, such as two-stroke engine braking.

Having thus implemented auxiliary valve motions through the selective coupling/decoupling of rocker arms, processing may continue at block 1208 where a determination is made whether positive power operation has been initiated. In an embodiment, such a determination may be once again made through detection of user-based and/or sensor-based inputs by a suitable controller. For example, where auxiliary valve motions were initiated through detection of a user input or specific set of sensor conditions, a change or discontinuation in the user input or specific sensor conditions may serve as the basis for initiating positive power operation. Additionally, to the extent that some auxiliary valve motions are not necessarily in conflict with main valve motions (e.g., EGR valve events), the initiation of positive power operation at block 1208 may be broadly interpreted to include those instances in which previously initiated auxiliary valve events not in conflict with main valve events are to be discontinued but main valve events are to continue. Regardless, processing thereafter continues at block 1210, where the one or more coupling mechanisms used to couple the first and second rocker arms at block 1204 are now controlled (in response to the determination at block 1208) to decouple the first rocker arm from the second rocker arm. In this manner, all auxiliary valve motions provided by the second rocker arm to the first rocker are discontinued. In the event that the auxiliary valve motions provided by the second rocker arm were the sole valve motions applied to the first rocker arm, processing may optionally continue at block 1212 where the one or more coupling mechanisms, previously controlled at block 1206 to decouple the first and third rocker arms, are once again controlled to couple the first and third rocker arms. In this manner, the main event valve motions provided by the third rocker arm are once again transferred to the first rocker arm and, consequently, to the at least one valve. Once again, it is noted that the particular ordering of blocks 1210 and 1212 is not a requirement and that the order of these blocks could be reversed as a matter of design choice.

Referring now to FIGS. 13-28, various configurations of multiple rocker arms and corresponding coupling mechanisms are illustrated. Beginning with FIG. 13, a main rocker arm 1302 and an auxiliary rocker arm 1304 are disposed adjacent each other on a rocker arm shaft 1306, and such that the main and auxiliary rocker arms 1302, 1304 are free to rotate about the rocker arm shaft 1306. As shown, the rocker arm shaft 1306 may include an internal passage 1308 that may provide pressurized hydraulic fluid (such as engine oil by way of non-limiting example) to either or both of the main and auxiliary rocker arms 1302, 1304.

In the illustrated embodiment, both the main rocker arm 1302 and auxiliary rocker arm 1304 include respective roller followers 1310, 1312 that contact corresponding cams 1314, 1316 rotating about a camshaft 1318. As known in the art, a main cam 1314 may be configured to provide main event valve motions (e.g., either intake or exhaust main event valve motions) whereas an auxiliary cam 1316 may be configured to provide auxiliary valve motions (e.g., engine braking valve motions). Although roller followers 1310, 1312 are illustrated in contact with the cams 1314, 1316, those having skill in the art will appreciate that other linking mechanisms (e.g., tappets, pushrods, etc.) may be equally employed for this purpose.

As further shown, a distal end (relative to the camshaft 1318) of the main rocker arm 1302 may be operatively connected to one or more engine valves. In the illustrated example, a valve bridge 1303 is employed for this purpose, though it is appreciated that this is not a requirement.

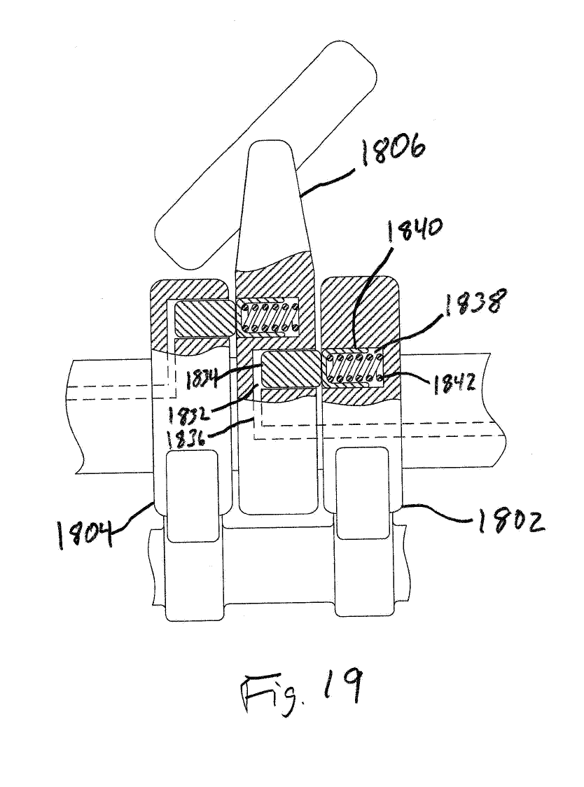

A coupling mechanism 1320 is provided spanning the boundary between the main rocker arm 1302 and the auxiliary rocker arm 1304. In this embodiment, the coupling mechanism comprises a first or main bore 1322 formed in the main rocker arm 1302. As shown, the first bore 1322 is formed transverse to the longitudinal length of the main rocker arm 1302 and having an open end on a lateral surface of the main rocker arm 1302 facing the auxiliary rocker arm 1304. A sliding member 1324 is disposed within the first bore 1322. The sliding member has a longitudinal length such that it may be fully retracted within the first bore 1322. The first bore is provided with a hydraulic passage 1326 in fluid communication with the internal passage 1308. Within the auxiliary rocker arm 1304, a second or auxiliary bore 1328 is formed such that it may be axially aligned with the first bore 1322 when both of the cams 1314, 1316 are at base circle relative to the roller followers 1310, 1312, i.e., when no valve motions are being imparted to the respective rocker arms 1302, 1304. As with the first bore 1322, the second bore 1328 is formed transverse to the longitudinal length of the auxiliary rocker arm 1304 with an open end on a lateral surface of the auxiliary rocker arm 1404 facing the main rocker arm 1302. A biasing mechanism may be disposed within the second bore; in the illustrated embodiment, the biasing mechanism comprises a bias piston 1330 and a bias spring 1332 configured to urge the bias piston toward the open end of the second bore. Additionally, a stop mechanism may be employed to prevent extension of the bias piston 1330 out of the second bore 1332, i.e., such that an end face of the bias piston 1330 does not substantially extend past the plane of the lateral surface in which the open end of second bore 1328 resides. Techniques for implementing such stop mechanisms are well known in the art. Examples of such stop mechanisms include: a stepped bore and piston with a cap nut or other device at a closed end bore (an example of which is illustrated in FIGS. 16 and 17) or a pin in a piston that rides in a slot formed in the bore wall configured to limit travel of the piston. In an embodiment, a longitudinal length of the bias piston 1330 is selected such that travel of the bias piston 1330 into the second bore will be limited by abutment of the bias piston 1330 with an end wall of the second bore 1328 before a compression limit of the bias spring 1332 is reached.

As shown in FIG. 13, when the hydraulic passage 1326 is not charged with hydraulic fluid, and assuming axial alignment of the first and second bores 1322, 1328, the bias provided by the combination of the bias piston 1330 and bias spring 1332 will urge the sliding member 1324 into the first bore 1322. In general, it is desirable for the sliding member 1324 and bias piston 1330 to be configured such that, when retracted into their respective bores, these components will not affect or otherwise interfere with the ability of the rocker arms 1302, 1304 to move. For example, in an embodiment, the length of the sliding member 1324 is selected such that it does not substantially extend out of the first bore 1322 when fully retracted therein. In this manner, the abutting end surfaces of the sliding member 1324 and bias piston 1330 are free to slide past each other as motions from the cams 1314, 1316 are imparted to the respective rocker arms 1302, 1304. As a further example, the edges defining the abutting ends of either or both of the sliding member 1324 and bias piston 1330 may be beveled, chamfered or rounded to minimize likelihood of catching with other moving components. It is noted that these considerations concerning the configuration of the sliding member 1324 and the bias piston 1330 are equally applicable to the other embodiments described hereinbelow.

However, as illustrated in FIG. 14, when the hydraulic passage 1326 is charged with hydraulic fluid, the biasing force applied by the bias spring 1332 is overcome by the pressurized hydraulic fluid, thereby causing the sliding member 1324 to extend out of the first bore 1322. While the sliding member 1324 is preferably dimensioned to closely match the dimensions of the first bore 1322 such that the pressure applied by the hydraulic fluid is sufficient to cause movement of the sliding member 1324, those having skill in the art will appreciate that some leakage of hydraulic fluid between the sliding member 1324 and the first bore 1322 can be tolerated. As the sliding member 1324 extends out of the first bore 1322 and into the second bore 1328, the bias piston 1330 is pushed further into the second bore 1328 until it abuts the end wall of the second bore 1328, as shown in FIG. 14. So long as the hydraulic passage 1326 is sufficiently pressurized by the hydraulic fluid, the sliding member 1324 will remain partially within the first and second bores 1322, 1328 thereby effectively coupling the main rocker arm 1302 and the auxiliary rocker arm 1304 together. When the hydraulic passage 1326 is no longer pressurized, the force of the bias spring 1332 will once again cause the bias piston 1330 to extend, thereby causing the sliding member 1324 to retract into the first bore and decoupling the main and auxiliary rocker arms 1302, 1304.

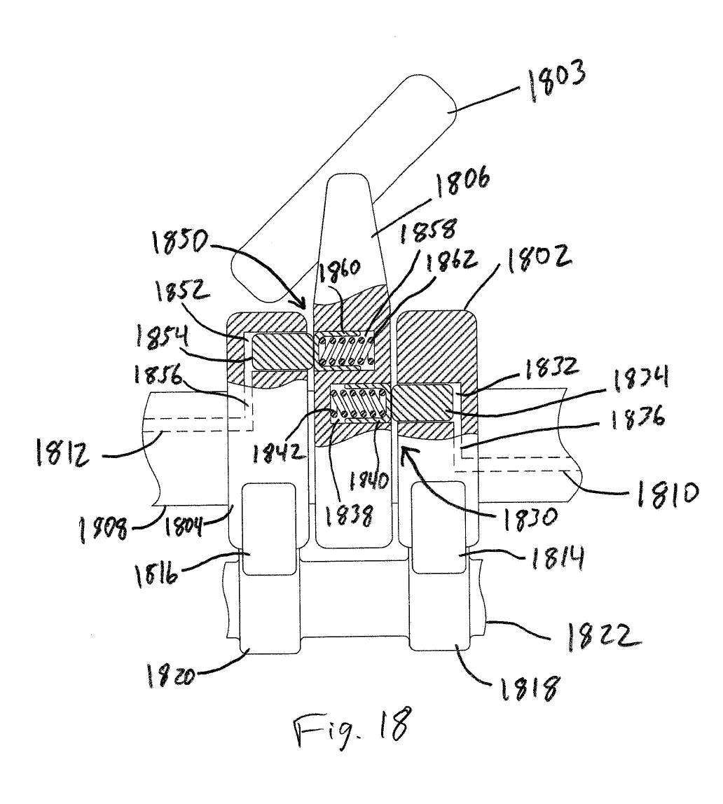

FIG. 15 illustrates an embodiment substantially similar to FIGS. 13 and 14, with the exceptions that disposition of the first and second bores 1322, 1328 and the relevant components of the coupling mechanism are reversed relative to the main and auxiliary rocker arms 1302, 1304. Thus, the first bore 1322 and sliding member 1324 are disposed within the auxiliary rocker arm 1304, as is the hydraulic passage 1326, as shown. Likewise, the second bore 1328, bias piston 1330 and bias spring 1332 are disposed within the main rocker arm 1302. Operation of the sliding member 1324 is otherwise the same as described above relative to FIGS. 13 and 14.

As described above, the biasing mechanism illustrated in FIGS. 13-15 is disposed with the second bore in opposition to the sliding member 1324. In an alternative embodiment, the biasing mechanism may be implemented within a single bore, specifically the same bore in which the sliding member is disposed, as illustrated in FIGS. 16 and 17. As shown therein, a first bore 1606 is formed in a first rocker arm 1602 and a second bore 1608 is formed in a second rocker arm 1604. Additionally, a sliding member 1610 is disposed within the first bore 1606, and a hydraulic passage 1612 is in fluid communication with the first bore 1606 and an end of the sliding member 1610. In this embodiment, however, a stop 1614 is arranged at the open end of the first bore 1606, and a bias spring 1616 is arranged between the stop 1614 and a shoulder of the sliding member 1610. As shown, a surface of the shoulder is opposite the end of the sliding member 1610 in communication with the hydraulic passage 1612. Contact of the bias spring with this surface urges the sliding member 1610 into the first bore 1606. Once again, longitudinal length of the sliding member 1610 is selected such that the sliding member 1610 does not substantially extend out of the first bore 1606 when fully retracted into the first bore 1606. In this embodiment, introduction of pressurized hydraulic fluid into the hydraulic passage 1612 places sufficient pressure on the end of the sliding member 1610 to overcome the force of the bias spring 1616, thereby permitting a reduced-diameter portion of the sliding member 1610 to extend past the stop 1614 and out of the first bore 1606 into second bore 1608. As shown, the second bore 1608 is configured to have dimensions closely matching the dimensions of the reduced-diameter portion of the sliding member 1610, i.e., within tolerances sufficient to ensure reception of the sliding member 1610 within the second bore 1608.

Referring now to FIG. 18, an embodiment is illustrated in which a main rocker arm 1802, an auxiliary rocker arm 1804 and a neutral rocker arm 1806 are disposed on a rocker arm shaft 1806 free to rotate about the rocker arm shaft 1808. The neutral rocker arm 1806 is disposed adjacent to both the main rocker arm 1802 and the auxiliary rocker arm 1804, i.e., between the main and auxiliary rocker arms 1802, 1804. In this embodiment, the rocker arm shaft 1808 includes a first or main internal passage 1810 and a second or auxiliary internal passage 1812, each of which may provide pressurized hydraulic fluid (such as engine oil by way of non-limiting example) to corresponding ones of the main and auxiliary rocker arms 1802, 1804. It is noted that, for ease of illustration, the main and auxiliary internal passages 1810, 1812 are not shown extending the length of the rocker arm shaft 1808. However, this would be the case in practice in order to provide pressurized hydraulic fluid to each cylinder and its corresponding rocker arm arrangements.

In the illustrated embodiment, both the main rocker arm 1802 and auxiliary rocker arm 1804 include respective roller followers 1814, 1816 that contact corresponding cams 1818, 1820 rotating about a camshaft 1822. As with the embodiments of FIGS. 13-15, a main cam 1818 may be configured to provide main event valve motions whereas an auxiliary cam 1820 may be configured to provide auxiliary valve motions. Once again, linking mechanisms other than the roller followers 1814, 1816 may be equally employed to receive motions from the corresponding cams 1818, 1820.

In the embodiment of FIG. 18, a distal end (relative to the camshaft 1822) of the neutral rocker arm 1806 may be operatively connected to one or more engine valves. In the illustrated example, a valve bridge 1803 is employed for this purpose, though it is appreciated that this is not a requirement.

As further illustrated in FIG. 18, two coupling mechanisms are provided spanning the boundaries between the main rocker arm 1802 and the neutral rocker arm 1806, and between the auxiliary rocker arm 1804 and the neutral rocker arm 1806. In this embodiment, a main coupling mechanism 1830 comprises a first bore 1832 formed in the main rocker arm 1802. As shown, the first bore 1832 is formed transverse to the longitudinal length of the main rocker arm 1802 and having an open end on a lateral surface of the main rocker arm 1802 facing the neutral rocker arm 1806. A sliding member 1834 is disposed within the first bore 1832. The sliding member has a longitudinal length such that it may be fully retracted within the first bore 1832. The first bore is provided with a main hydraulic passage 1836 in fluid communication with the main internal passage 1810. Within the neutral rocker arm 1806, a second bore 1838 is formed such that it may be axially aligned with the first bore 1832 when both of the cams 1818, 1820 are at base circle relative to the roller followers 1814, 1816, i.e., when no valve motions are being imparted to the respective rocker arms 1802, 1804. As with the first bore 1832, the second bore 1838 is formed transverse to the longitudinal length of the neutral rocker arm 1806 with an open end on a lateral surface of the neutral rocker arm 1806 facing the main rocker arm 1802. A biasing mechanism may be disposed within the second bore; in the illustrated embodiment, the biasing mechanism comprises a main bias piston 1840 and a main bias spring 1842 configured to urge the main bias piston toward the open end of the second bore. Additionally, a stop mechanism may be employed to prevent extension of the main bias piston 1840 out of the second bore 1838, i.e., such that an end face of the main bias piston 1840 does not substantially extend past the plane of the lateral surface in which the open end of second bore 1838 resides. In an embodiment, a longitudinal length of the main bias piston 1840 is selected such that travel of the main bias piston 1840 into the second bore will be limited by abutment of the main bias piston 1840 with an end wall of the second bore 1838 before a compression limit of the main bias spring 1842 is reached.

Additionally, FIG. 18 illustrates an auxiliary coupling mechanism 1850 that comprises a third bore 1852 formed in the auxiliary rocker arm 1804. As shown, the third bore 1852 is formed transverse to the longitudinal length of the auxiliary rocker arm 1804 and having an open end on a lateral surface of the auxiliary rocker arm 1804 facing the neutral rocker arm 1806. A sliding member 1854 is disposed within the third bore 1852. The sliding member has a longitudinal length such that it may be fully retracted within the third bore 1852. The third bore is provided with an auxiliary hydraulic passage 1856 in fluid communication with the auxiliary internal passage 1812. Within the neutral rocker arm 1806, a fourth bore 1858 is formed such that it may be axially aligned with the third bore 1852 when both of the cams 1818, 1820 are at base circle relative to the roller followers 1814, 1816, i.e., when no valve motions are being imparted to the respective rocker arms 1802, 1804. As with the third bore 1852, the fourth bore 1858 is formed transverse to the longitudinal length of the neutral rocker arm 1806 with an open end on a lateral surface of the neutral rocker arm 1806 facing the auxiliary rocker arm 1804. A biasing mechanism may be disposed within the fourth bore; in the illustrated embodiment, the biasing mechanism comprises an auxiliary bias piston 1860 and a bias spring 1862 configured to urge the auxiliary bias piston toward the open end of the fourth bore. Additionally, a stop mechanism may be employed to prevent extension of the auxiliary bias piston 1860 out of the fourth bore 1858, i.e., such that an end face of the auxiliary bias piston 1860 does not substantially extend past the plane of the lateral surface in which the open end of fourth bore 1858 resides. In an embodiment, a longitudinal length of the auxiliary bias piston 1860 is selected such that travel of the auxiliary bias piston 1860 into the fourth bore will be limited by abutment of the auxiliary bias piston 1860 with an end wall of the fourth bore 1858 before a compression limit of the auxiliary bias spring 1862 is reached.

Similar to the embodiment of FIG. 13, when either the main hydraulic passage 1836 or the auxiliary hydraulic passage 1856, or both, is charged with hydraulic fluid, the corresponding main sliding member 1834 or auxiliary sliding member 1854, or both, may be extending into respective ones of the second and fourth bores 1838, 1858. In this manner, the neutral rocker arm 1806 can be coupled to/decoupled from either the main rocker arm 1802 or the auxiliary rocker arm 1804, or both, thereby providing complete control as to what valve motions (i.e., auxiliary valve motions, main valve motions, both or none) are provided to the neutral rocker arm 1806 and, consequently, to the one or more engine valves.

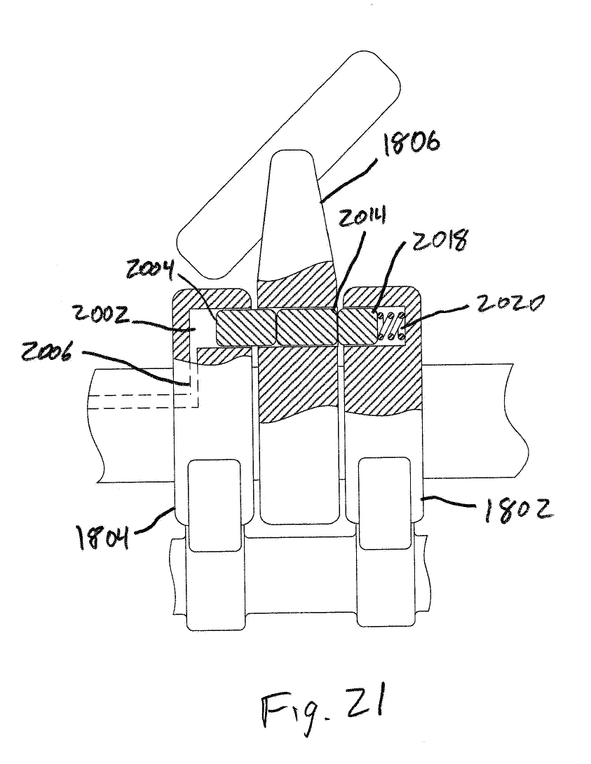

FIG. 19 illustrates an embodiment substantially similar to FIG. 18 with the exceptions that disposition of the first and second bores 1832, 1838 and the relevant components of the main coupling mechanism are reversed relative to the main and neutral rocker arms 1802, 1806. Thus, the first bore 1832 and main sliding member 1834 are disposed within the neutral rocker arm 1806, as is the main hydraulic passage 1836, as shown. Likewise, the second bore 1838, main bias piston 1840 and main bias spring 1842 are disposed within the main rocker arm 1802. Operation of the main sliding member 1834 is otherwise the same as described above relative to FIG. 18.

Furthermore, though not illustrated in the instant Figures, and similar to the reversal illustrated in FIG. 19, in another embodiment, disposition of the third and fourth bores 1852, 1858 and the relevant components of the auxiliary coupling mechanism are reversed relative to the auxiliary and neutral rocker arms 1804, 1806. Thus, the third bore 1852 and auxiliary sliding member 1854 are disposed within the neutral rocker arm 1806, as is the auxiliary hydraulic passage 1856. Likewise, the fourth bore 1858, auxiliary bias piston 1860 and auxiliary bias spring 1862 are disposed within the auxiliary rocker arm 1804. In this embodiment, operation of the auxiliary sliding member 1854 would otherwise be the same as described above relative to FIG. 18.

Further still, though not illustrated in the instant Figures and in keeping with the embodiment illustrated in FIG. 19, in yet another embodiment, both the main and auxiliary hydraulic passages 1836, 1856 could be disposed within the neutral rocker arm 1806. In this case, both the first and third bores 1832, 1852 and the corresponding main and auxiliary sliding members 1834, 1854 are also disposed in the neutral rocker arm 1806, with the corresponding bias mechanisms disposed within the respective main and auxiliary rocker arms 1802, 1804.

Once again, the alternative biasing mechanism illustrated in FIGS. 16 and 17 may be used instead of either or both of the biasing mechanisms illustrated in FIGS. 18 and 19, or the further embodiments noted above.

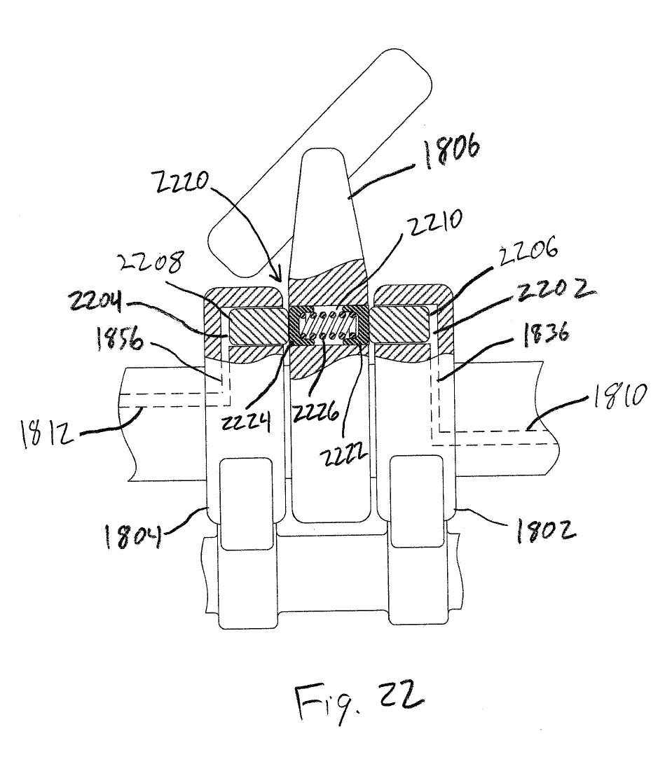

Referring now to FIGS. 20 and 21, an embodiment similar to that shown in FIG. 18 is further illustrated. That is, the embodiment illustrated in FIGS. 20 and 21 comprises a main rocker arm 1802, auxiliary rocker arm 1804 and neutral rocker arm 1806 as before. In this embodiment, however, each of the rocker arms 1802-1806 comprises a single bore in order to implement the main coupling mechanism and the auxiliary coupling mechanism. In particular, a second bore disposed in the neutral rocker arm 1806 is co-axially aligned with first and third bores disposed with in the auxiliary and main rocker arms 1804, 1802, and therefore shared by both the auxiliary coupling mechanism and the main coupling mechanism.

In particular, and with reference to FIG. 20, the auxiliary rocker arm 1804 comprises a first bore 2002 and an auxiliary sliding member 2004 disposed therein. The first bore 2002 is in fluid communication with an auxiliary hydraulic passage 2006 that, in turn, is in fluid communication with an auxiliary internal passage 2008 within the rocker arm shaft 2010. In all relevant aspects, the first bore 2002 and auxiliary sliding member 2004 are substantially similar to the first bore and sliding member described above relative to FIGS. 15 and 18, for example.

In the embodiment of FIG. 20, however, a second bore 2012 is formed in the neutral rocker arm 1806, which second bore 2012 (unlike the above-described embodiments) passes through the entire width of the neutral rocker arm 1806, i.e., it has two open ends on opposite lateral surfaces of the neutral rocker arm 1806. The second bore 2012 co-axially aligns with the first bore 2002 in the same manner as described above. Furthermore, as shown, a neutral sliding member 2014 is disposed within the second bore 2012, which neutral sliding member 2014 has a longitudinal length that is less than the longitudinal length of the second bore 2012, and is free to travel along the entire length of the second bore 2012. Further still, a third bore 2016 is formed in the main rocker arm 1802, which third bore 2016 is co-axially aligned with the second bore 2012 and, consequently, the first bore 2002 as well. Within the third bore 2016, a main sliding member 2018 is disposed along with a main bias spring 2020 that biases the main sliding member 2018 out of the third bore 2016. As shown in FIG. 20, the longitudinal length of the main sliding member 2018 is selected such that it extends out of the third bore 2016 to the extent permitted by the abutment of the main sliding member 2018, neutral sliding member 2014 and auxiliary sliding member 2004, as described below.

Given axial alignment of the first, second and third bores 2002, 2012, 2016, and absent the auxiliary hydraulic passage 2006 being charged with hydraulic fluid (as in the case, for example, where auxiliary motions are not currently enabled), the force applied by the main bias spring 2020 to the main sliding member 2012 causes the main sliding member 2018 to extend out of the third bore 2016 and into abutment with the neutral sliding member 2014 within the second bore 2012. In turn, this causes the neutral sliding member 2014 into abutment with the auxiliary sliding member 2004, thereby causing the auxiliary sliding member 2004 to retract fully within the first bore 2002. Given the relative lengths of the sliding members 2004, 2014, 2018, the result of this arrangement is to couple the main rocker arm 1802 to the neutral rocker arm 1806 and to decouple the auxiliary rocker arm 1804 from the neutral rocker arm 1806. This configuration represents a default state (i.e., when the auxiliary hydraulic passage 2006 is not charged) in which main valve motions are enabled and auxiliary valve motions are disabled.

As shown in FIG. 21, however, charging of the auxiliary hydraulic passage 2006 pressurizes the first bore 2002 to a level sufficient to overcome the force applied by the main bias spring 2020, thereby causing the auxiliary sliding member 2004 to extend out of the first bore 2002 and into the second bore 2012. The abutment of the auxiliary sliding member 2004 with the neutral sliding member 2014, and the corresponding abutment of the neutral sliding member 2014 with the main sliding member 2018 causes retraction of the main sliding member 2018 fully into the third bore 2016. However, the length of the neutral sliding member 2014 (potentially along with the provision of a stop within the second bore 2012) prevents extension of the neutral sliding member 2014 into the third bore 2016. The result of this arrangement, then, is to decouple the main rocker arm 1802 from the neutral rocker arm 1806 and to couple the auxiliary rocker arm 1804 to the neutral rocker arm 1806. This configuration represents an activated state (i.e., when the auxiliary hydraulic passage 2006 is charged) in which auxiliary valve motions enabled and main valve motions are disabled.

As noted, the embodiment illustrated in FIGS. 20 and 21 effectively implement a “main valve events by default” configuration where failure to pressurize the auxiliary hydraulic passage 2006 causes the main and auxiliary coupling mechanisms to couple on the main and neutral rocker arms. Of course, it is possible to make provision of pressurized hydraulic fluid the default state, thereby ensuring coupling of the auxiliary and neutral rocker arms as the default. Further still, the arrangement of the hydraulic passage 2006, sliding members and bias mechanism between the auxiliary and main rocker arms could be reversed such that failure to pressurize the hydraulic passage 2006 (now disposed within the main rocker arm 1802) would result in an “auxiliary valve events by default” configuration in which the auxiliary and neutral rocker arms are coupled together and the main and neutral rocker arms are decoupled during such default operation.

Once again, the alternative biasing mechanism illustrated in FIGS. 16 and 17 may be used instead of either or both of the biasing mechanisms illustrated in FIGS. 20 and 21.

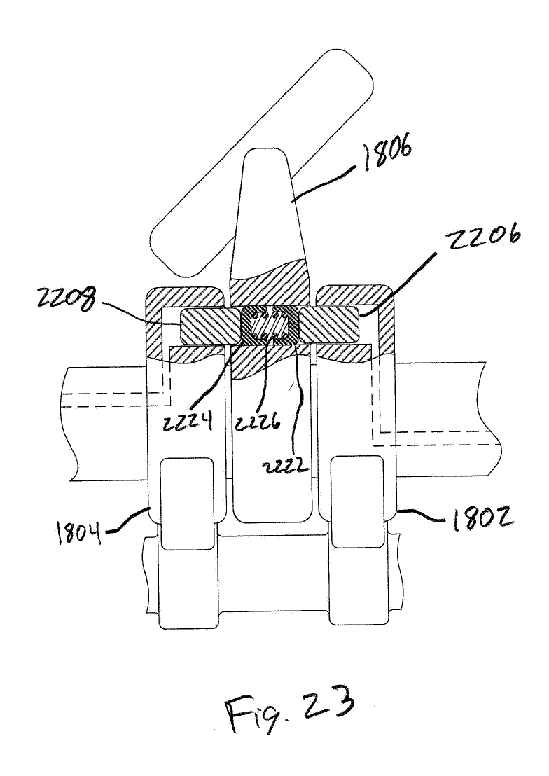

Referring now to FIGS. 22 and 23, an embodiment combining features from the embodiment of FIG. 18 with features from the embodiment of FIG. 20 is illustrated. In particular, like the embodiment of FIG. 18, the main and auxiliary rocker arms 1802, 1804 are provided with respective main and auxiliary hydraulic passages 1836, 1856. The main and auxiliary hydraulic passages 1836, 1856 are in fluid communication with first and second bores 2202, 2204, respectively. In turn, the first and second bores 2202, 2204 are each in axial alignment with a third bore 2210 formed in the neutral rocker arm 1806, as illustrated in FIG. 22. The first bore 2202 has a main sliding member 2206 is disposed therein, whereas the second bore 2204 has an auxiliary sliding member 2208 disposed therein, as shown. Within the third bore 2210, a neutral sliding member assembly 2220 is provided. The neutral sliding member assembly 2220 comprises a main bias piston 2222 arranged in the second bore 2210 opposite the main sliding member 2206, an auxiliary bias piston 2224 arranged in the second bore 2210 opposite the auxiliary sliding member 2208 and a bias spring 2226 arranged between the main bias piston 2222 and the auxiliary bias piston 2224. Operation of the bias spring 2226 urges the main bias piston 2222 and the auxiliary bias piston 2224 in the directions of the respective openings of the third bore 2210. In an embodiment, stops may be provided to prevent extension of the main bias piston 2222 and the auxiliary bias piston 2224 out of the third bore 2210.

Configured in this manner, and absent charging of the main and auxiliary hydraulic passages 1836, 1856 with pressurized hydraulic fluid, the bias provided by the main bias piston 2222 and the auxiliary bias piston 2224 causes the main and auxiliary sliding members 2206, 2208 to fully retract into the first and second bores 2202, 2204, respectively. In this state, neither the main rocker arm 1802 or the auxiliary rocker arm 1804 are coupled to the neutral rocker arm 1806. However, charging of either the main hydraulic passage 1836 or auxiliary hydraulic passage 1856 will cause the force of the bias spring 2226 to be overcome, resulting in the extension of the corresponding main or auxiliary sliding member 2206, 2208 into the third bore 2210. In this manner, either the main rocker arm 1802 or the auxiliary rocker arm 1804 may be coupled to the neutral rocker arm 1806. FIG. 23 illustrates the situation in which both the main hydraulic passage 1836 and auxiliary hydraulic passage 1856 is charged with hydraulic fluid. The resulting extension of both the main and auxiliary sliding members 2206, 2208 into the third bore 2210 causes both the main and auxiliary rocker arms 1802, 1804 to be coupled to the neutral rocker arm 1806.

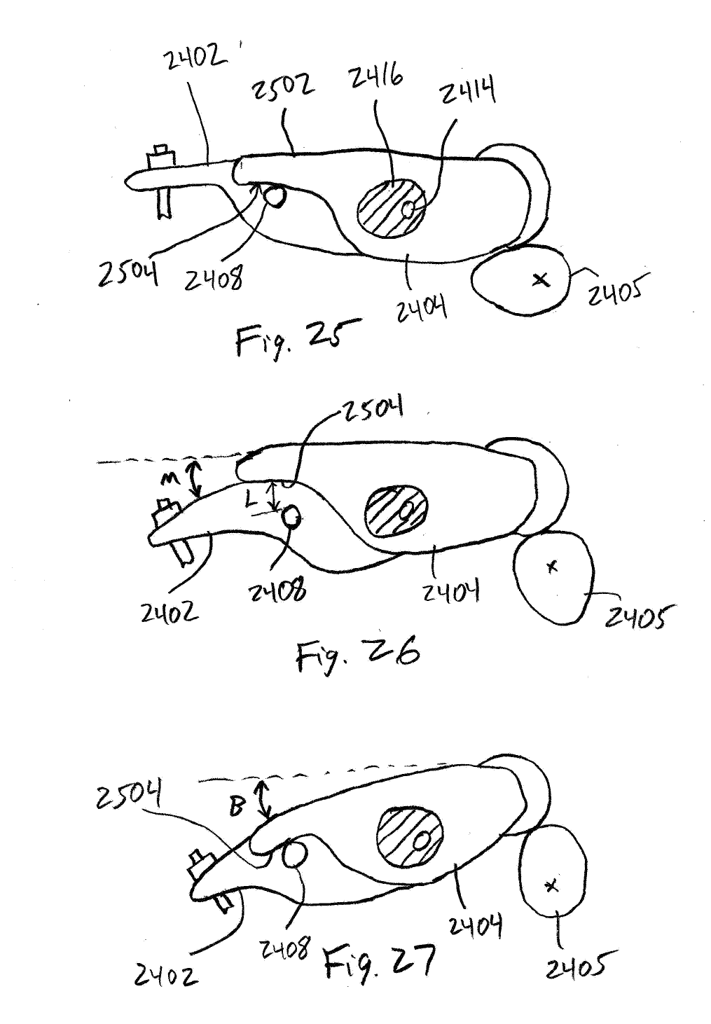

Referring now to FIGS. 24-27, an embodiment employing multiple rocker arms and a one-way coupling mechanism is illustrated. Referring now to FIG. 24, an implementation employing a main rocker arm 2402 and an auxiliary rocker arm 2404 is illustrated. As in prior embodiments described above, the auxiliary rocker arm 2404 may be operatively connected to an auxiliary cam 2405 and the main rocker arm 2402 may be operatively connected to a main cam 2403. As shown, a one-way coupling mechanism 2406 is implemented using an auto-biased, sliding member assembly substantially similar to that disclosed in FIGS. 16 and 17. In particular, a sliding member 2408 is disposed within a bore 2410 formed within the main rocker arm 2402. As in the embodiments described above, the bore 2410 is formed having a longitudinal axis substantially transverse to the longitudinal axis of the main rocker arm 2402, and having an opening in a lateral surface of the main rocker arm 2402 facing the auxiliary rocker arm 2404. An hydraulic passage 2412 is in fluid communication with the bore 2410 as well as an internal passage 2414 of the rocker arm shaft 2416. A bias spring 2418, operating in conjunction with a stop 2420, biases the sliding member 2408 into the bore 2410. Once again, a length of the sliding member 2408 is selected such that the sliding member 2410, when fully retracted into the bore 2410, does not extend out of the bore 2410. However, charging of the hydraulic passage 2412 with hydraulic fluid results, as shown in FIG. 24, in extension of the sliding member 2408 out of the bore 2410. In this embodiment, however, extension of the sliding member 2408 does not engage a corresponding bore formed, in this case, in the auxiliary rocker arm 2404. Instead, the extended sliding member 2408 is configured to contact an upward-facing or downward-facing surface of the auxiliary rocker arm, or to engage a slot formed in the auxiliary rocker arm. Examples of these embodiments are further illustrated in FIGS. 25-28.

In FIGS. 25-27, a partial side view of the system illustrated in FIG. 24 is shown. In particular, the sliding member 2408 is shown extending out of the main rocker arm 2402. In this implementation, the auxiliary rocker arm 2404 comprises a cantilevered arm 2502 having a downward-facing surface 2504. As shown in FIG. 25, when the cams 2403, 2405 are at base circle, the sliding member 2408 may be in contact with the downward-facing surface 2504 of the auxiliary rocker arm 2404. Thereafter, as shown in FIG. 25, occurrence of a main valve event (by virtue of the main cam 2403) causes the main rocker arm 2402 to rotate by an amount, M, as defined by the cam profile. Because the sliding member 2408 is not confined within a bore in the auxiliary rocker arm 2404, rotation of the main rocker arm 2402 does not induce similar movement in the auxiliary rocker arm 2404, but instead gives rise to a lash space, L, between the sliding member 2408 and the downward-facing surface 2504.

As further depicted in FIG. 27, after occurrence of the main valve event, rotation of the auxiliary cam 2405 induces a corresponding rotation, B, in the auxiliary rocker arm 2404. In this case, however, the downward-facing surface 2504 of the auxiliary rocker arm 2404 maintains contact with the sliding member 2408, thereby transferring the rotation, B, to the main rocker arm 2402 and, consequently, the one or more engine valves operatively connected to the main rocker arm 2402. In this manner, motions from the auxiliary rocker arm 2404 to the main rocker arm 2402 are transferred, whereas motions from the main rocker arm 2402 to the auxiliary rocker arm 2404 are not transferred.

Those having skill in the art will first appreciate that the sliding member 2408 may be equally deployed within the auxiliary rocker arm 2404 and, further, that the location of the sliding member on either side of the fulcrum point of the rocker arm in which it is disposed will dictate whether it should contact a downward- or upward-facing surface of the adjacent rocker arm. For example, if the sliding member 2408 in the main rocker arm 2402 were disposed on the opposite side of the main rocker arm's fulcrum point (i.e., the rocker arm shaft 2416), then it would need to contact an upward-facing surface on the auxiliary rocker arm 2404 in order to function in the same manner.

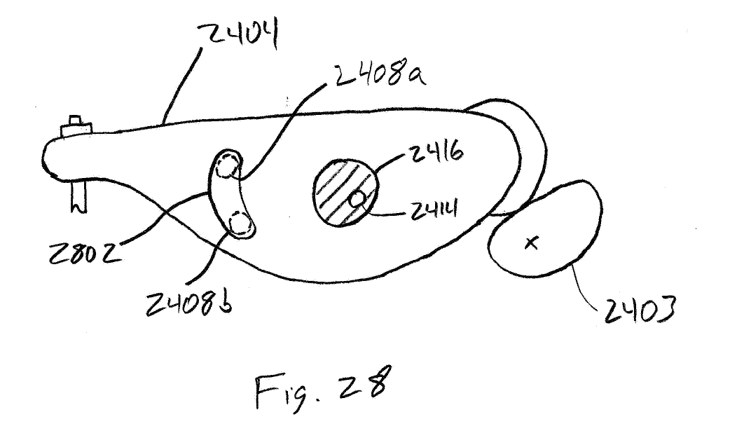

In yet another alternative embodiment illustrated in FIG. 28, it is assumed that the sliding member 2408 is disposed within the auxiliary rocker arm 2404 (not shown in FIG. 28). In this case, the sliding member 2408, when extended, may engage a slot 2802 formed in a lateral surface of the main rocker arm 2402 facing the auxiliary rocker arm 2404. As further shown in FIG. 28, the sliding member 2408 may be particularly configured to make contact with either end of the slot 2802 as illustrated by reference numerals 2408a and 2408b. Given the rotation of the main rocker arm 2402, the slot 2802 preferably has an arcuate shape, though this is not a requirement based on how closely the dimensions of the sliding member match those of the slot. Regardless, in this manner, main valve events may be lost relative to the sliding member 2408 which otherwise simply travels along the slot during such main valve events. In contrast, auxiliary valve events cause the sliding member to engage the end of the slot, thereby transferring the auxiliary valve motion to the main rocker arm.

What is claimed is:

1. A method for performing auxiliary valve motions in a system comprising an internal combustion engine having a plurality of cylinders, each cylinder of the plurality of cylinders having at least one valve train configured to convey valve actuation motions from at least one valve actuation motion source to at least one valve associated with the cylinder, the method comprising:
determining that engine braking operation has been initiated;
responsive to initiation of engine braking operation, activating a deactivation mechanism disposed within a main valve train thereby disabling conveyance of main valve events from a main valve actuation motion source to a valve via the main valve train; and
responsive to initiation of engine braking operation, enabling engine braking valve events for the valve,
wherein the engine braking valve events implement two-stroke engine braking.

2. A method for performing engine braking in a system comprising an internal combustion engine having a plurality of cylinders, each cylinder of the plurality of cylinders having a plurality of rocker arms associated therewith configured to convey valve actuation motions from a plurality of valve actuation motion sources to at least one valve associated with the cylinder, the plurality of rocker arms arranged adjacent each other and defining boundaries therebetween, the plurality of rocker arms further comprising at least one coupling mechanism for each boundary between the plurality of rocker arms, each of the at least one coupling mechanism configured to selectively couple or decouple two adjacent rocker arms of the plurality of rocker arms, the method further comprising:
determining that engine braking operation has been initiated; and
responsive to initiation of engine braking operation, controlling the at least one coupling mechanism to couple a first rocker arm of the plurality of rocker arms to a second rocker arm of the plurality of rocker arms, the first rocker arm being operatively connected to the at least one valve and the second rocker arm being operatively connected to an engine braking motion source of the plurality of valve actuation motion sources.

3. The method of claim 2, further comprising:
responsive to initiation of engine braking operation, controlling the at least one coupling mechanism to decouple the first rocker arm from a third rocker arm of the plurality of rocker arms, the third rocker arm being operatively connected to a main event motion source of the plurality of valve actuation motion sources.

4. The method of claim 3, wherein the engine braking motion source implements two-stroke engine braking.

5. The method of claim 2, further comprising:
determining that positive power operation has been initiated; and
responsive to initiation of positive power operation, controlling the at least one coupling mechanism to decouple the first rocker arm from the second rocker arm.

6. The method of claim 5, further comprising:
responsive to initiation of positive power operation, controlling the at least one coupling mechanism to couple the first rocker arm to a third rocker arm of the plurality of rocker arms, the third rocker arm being operatively connected to a main event motion source of the plurality of valve actuation motion sources.

7. A system for operating an internal combustion engine comprising a plurality of cylinders, a cylinder of the plurality of cylinders having a plurality of valves associated therewith, the system comprising:
a main event motion source configured to provide main event valve motions to at least one valve of the plurality of valves;
an auxiliary motion source configured to provide auxiliary valve motions to at least one valve of the plurality of valves;
a main rocker arm operatively connected to the main event motion source;
an auxiliary rocker arm operatively connected to the auxiliary motion source;
a neutral rocker arm operatively connected to at least one valve of the plurality of valve and adjacent to the main rocker arm and the auxiliary rocker arm;
a main coupling mechanism configured to selectively couple or decouple the main rocker arm and the neutral rocker arm; and
an auxiliary coupling mechanism configured to selectively couple or decouple the auxiliary rocker arm and the neutral rocker arm.

8. The system of claim 7 wherein the auxiliary coupling mechanism comprises:
a first bore formed in the auxiliary rocker arm and an auxiliary sliding member disposed therein, the auxiliary rocker arm further comprising an auxiliary hydraulic passage in communication with an end of the auxiliary sliding member; and
a second bore formed in the neutral rocker arm and configured to align with the first bore such that the auxiliary sliding member may selectively extend from the first bore into the second bore when the auxiliary hydraulic passage is charged with hydraulic fluid.

9. The system of claim 8, wherein the auxiliary coupling mechanism further comprises a biasing mechanism configured to bias the auxiliary sliding member into the first bore.

10. The system of claim 9, wherein the biasing mechanism comprises a spring disposed within the first bore and in contact with a surface of the auxiliary sliding member opposite the end of the auxiliary sliding member.

11. The system of claim 9, wherein the biasing mechanism comprises a spring-loaded bias piston disposed in the second bore opposite the auxiliary sliding member, the bias piston further comprising a stop preventing extension of the bias piston out of the second bore.

12. The system of claim 8, wherein the main coupling mechanism comprises:
a third bore formed in the main rocker arm and a main sliding member disposed therein, the main rocker arm further comprising a main hydraulic passage in communication with an end of the main sliding member; and
a fourth bore formed in the neutral rocker arm and configured to align with the third bore such that the main sliding member may selectively extend from the third bore into the fourth bore when the main hydraulic passage is charged with hydraulic fluid.

13. The system of claim 12, wherein the main coupling mechanism further comprises a biasing mechanism configured to bias the main sliding member into the third bore.

14. The system of claim 13, wherein the biasing mechanism comprises a spring disposed within the third bore and in contact with a surface of the main sliding member opposite the end of the main sliding member.

15. They system of claim 13, wherein the biasing mechanism comprises a spring-loaded bias piston disposed in the fourth bore opposite the main sliding member, the bias piston further comprising a stop preventing extension of the bias piston out of the fourth bore.

16. The system of claim 8, wherein the main coupling mechanism comprises:
a neutral sliding member disposed within the second bore;
a third bore formed in the main rocker arm and a spring-loaded main sliding member disposed therein,
wherein the second bore is further configured to align with the third bore such that,
when the auxiliary hydraulic passage is not charged with hydraulic fluid, the main sliding member extends from the third bore into the second bore and into contact with the neutral sliding member, and the neutral sliding member contacts the auxiliary sliding member thereby biasing the auxiliary sliding member into the first bore,
and when the auxiliary hydraulic passage is charged with hydraulic fluid, the auxiliary sliding member extends from the first bore into the second bore and into contact with the neutral sliding member, and the neutral sliding member contacts the main sliding member thereby biasing the main sliding member into the third bore.

17. The system of claim 8, wherein the main coupling mechanism comprises:
a third bore formed in the main rocker arm and a main sliding member disposed therein, the main rocker arm further comprising a main hydraulic passage in communication with an end of the main sliding member,
wherein the second bore is further configured to align with the third bore such that the main sliding member may selectively extend from the third bore into the second bore when the main hydraulic passage is charged with hydraulic fluid.

18. The system of claim 17,
wherein the auxiliary coupling mechanism comprises an auxiliary biasing mechanism configured to bias the auxiliary sliding member into the first bore, the auxiliary biasing mechanism further comprising a spring disposed within the first bore and in contact with a surface of the auxiliary sliding member opposite the end of the auxiliary sliding member,
and wherein the main coupling mechanism comprises a main biasing mechanism configured to bias the main sliding member into the third bore, the main biasing mechanism comprises a spring disposed within the third bore and in contact with a surface of the main sliding member opposite the end of the main sliding member.

19. The system of claim 17, further comprising:
a neutral sliding member disposed within the second bore, the neutral sliding member comprising a spring disposed between an auxiliary bias piston and a main bias piston, the auxiliary bias piston disposed opposite the auxiliary sliding member and the main bias piston disposed opposite the main sliding member, wherein both the auxiliary bias piston and the main bias piston comprise a stop preventing extension of the auxiliary bias piston and the main bias piston out of the second bore.

20. The system of claim 7, wherein the main coupling mechanism comprises:
a first bore formed in the main rocker arm and a main sliding member disposed therein, the main rocker arm further comprising a main hydraulic passage in communication with an end of the main sliding member;
a second bore formed in the neutral rocker arm and configured to align with the first bore such that the main sliding member may selectively extend from the first bore into the second bore when the main hydraulic passage is charged with hydraulic fluid; and
a neutral sliding member disposed within the second bore.

21. The system of claim 20, wherein the auxiliary coupling mechanism comprises:
a third bore formed in the auxiliary rocker arm and a spring-loaded auxiliary sliding member disposed therein,
wherein the second bore is further configured to align with the third bore such that,
when the main hydraulic passage is not charged with hydraulic fluid, the auxiliary sliding member extends from the third bore into the second bore and into contact with the neutral sliding member, and the neutral sliding member contacts the main sliding member thereby biasing the main sliding member into the first bore,
and when the main hydraulic passage is charged with hydraulic fluid, the main sliding member extends from the first bore into the second bore and into contact with the neutral sliding member, and the neutral sliding member contacts the auxiliary sliding member thereby biasing the auxiliary sliding member into the third bore.

22. The system of claim 7, wherein the main coupling mechanism comprises:
a first bore formed in the main rocker arm and a main sliding member disposed therein, the main rocker arm further comprising a main hydraulic passage in communication with an end of the main sliding member; and
a second bore formed in the neutral rocker arm and configured to align with the first bore such that the main sliding member may selectively extend from the first bore into the second bore when the main hydraulic passage is charged with hydraulic fluid.

23. The system of claim 7, wherein the auxiliary coupling mechanism comprises:
a first bore formed in the neutral rocker arm and an auxiliary sliding member disposed therein, the neutral rocker arm further comprising an auxiliary hydraulic passage in communication with an end of the auxiliary sliding member; and
a second bore formed in the auxiliary rocker arm and configured to align with the first bore such that the auxiliary sliding member may selectively extend from the first bore into the second bore when the auxiliary hydraulic passage is charged with hydraulic fluid.

24. The system of claim 7, wherein the main coupling mechanism comprises:
a first bore formed in the neutral rocker arm and a main sliding member disposed therein, the neutral rocker arm further comprising a main hydraulic passage in communication with an end of the main sliding member; and
a second bore formed in the main rocker arm and configured to align with the first bore such that the main sliding member may selectively extend from the first bore into the second bore when the main hydraulic passage is charged with hydraulic fluid.

25. The system of claim 7, wherein the auxiliary motion source is an engine braking motion source and the auxiliary valve motions are engine braking valve motions.

26. The system of claim 25, wherein the engine braking valve motions are two-stroke engine braking valve motions.

27. A system for performing auxiliary valve motions in an internal combustion engine comprising a plurality of cylinders, a cylinder of the plurality of cylinders having a plurality of valves associated therewith, the system comprising:
a main event motion source configured to provide main event valve motions to at least one valve of the plurality of valves;
an auxiliary motion source configured to provide auxiliary valve motions to at least one valve of the plurality of valves;
a main rocker arm operatively connected to the main event motion source and at least one valve of the plurality of valves;
an auxiliary rocker arm operatively connected to the auxiliary motion source; and
a one-way coupling mechanism configured to selectively couple or decouple the main rocker arm and the auxiliary rocker arm, wherein auxiliary valve motions are transferred from the auxiliary rocker arm to the main rocker arm and the main event valve motions are not transferred from the main rocker arm to the auxiliary rocker arm when the main rocker arm and the auxiliary rocker arm are coupled via the one-way coupling mechanism.

28. The system of claim 27, wherein the one-way coupling mechanism is disposed within the auxiliary rocker arm.

29. The system of claim 28, the one-way coupling mechanism comprising:
a bore formed in the auxiliary rocker arm and an auxiliary sliding member disposed therein, the auxiliary rocker arm further comprising an auxiliary hydraulic passage in communication with an end of the auxiliary sliding member,
wherein the auxiliary sliding member may selectively extend from the bore when the auxiliary hydraulic passage is charged with hydraulic fluid.

30. The system of claim 29, the one-way coupling mechanism further comprising an upward-facing surface on the main rocker arm, wherein the auxiliary sliding member is configured to contact the upward-facing surface when the auxiliary valve motions are transferred from the auxiliary rocker arm to the main rocker arm.

31. The system of claim 29, the one-way coupling mechanism further comprising a downward-facing surface on the main rocker arm, wherein the auxiliary sliding member is configured to contact the downward-facing surface when the auxiliary valve motions are transferred from the auxiliary rocker arm to the main rocker arm.

32. The system of claim 29, the one-way coupling mechanism further comprising a slot on the main rocker arm, wherein the auxiliary sliding member is configured to contact an end of the slot when the auxiliary valve motions are transferred from the auxiliary rocker arm to the main rocker arm.

33. The system of claim 27, wherein the one-way coupling mechanism is disposed within the main rocker arm.

34. The system of claim 33, the one-way coupling mechanism comprising:
a bore formed in the main rocker arm and an auxiliary sliding member disposed therein, the main rocker arm further comprising an auxiliary hydraulic passage in communication with an end of the auxiliary sliding member,
wherein the auxiliary sliding member may selectively extend from the bore when the auxiliary hydraulic passage is charged with hydraulic fluid.

35. The system of claim 34, the one-way coupling mechanism further comprising an upward-facing surface on the auxiliary rocker arm, wherein the auxiliary sliding member is configured to contact the upward-facing surface when the auxiliary valve motions are transferred from the auxiliary rocker arm to the main rocker arm.

36. The system of claim 34, the one-way coupling mechanism further comprising a downward-facing surface on the auxiliary rocker arm, wherein the auxiliary sliding member is configured to contact the downward-facing surface when the auxiliary valve motions are transferred from the auxiliary rocker arm to the main rocker arm.

37. The system of claim 34, the one-way coupling mechanism further comprising a slot on the auxiliary rocker arm, wherein the auxiliary sliding member is configured to contact an end of the slot when the auxiliary valve motions are transferred from the auxiliary rocker arm to the main rocker arm.

38. The system of claim 27, wherein the auxiliary motion source is an engine braking motion source and the auxiliary valve motions are engine braking valve motions.

39. The system of claim 38, wherein the engine braking valve motions are two-stroke engine braking valve motions.
